(19) United States
(12) Patent Application Publication
(10) Pub. No.: US 2009/0247291 A1
(43) Pub. Date: Oct. 1, 2009

(54) GAMING SYSTEM HAVING A COMMON GAME FOR GAMING MACHINES AND CONTROLLING METHOD THEREOF

(75) Inventor: Yukinori INAMURA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ARUZE Corp., Tokyo (JP)

(21) Appl. No.: 12/209,132

(22) Filed: Sep. 11, 2008

Related U.S. Application Data
(60) Provisional application No. 61/039,661, filed on Mar. 26, 2008.

(51) Int. Cl. A63F 9/24; A63F 13/00

(52) U.S. Cl. 463/27

(57) ABSTRACT

In a gaming system, slot games are executed, respectively, in a plurality of slot machines. When a common game execution determination is made in a center controller, a common game is executed in each of the slot machines. When the common game is executed, one of a plurality of partitioned regions set on a terminal display in each of the slot machines is selected, and symbols displayed in display regions included in the selected partitioned region are displayed on a common display. Specifically, on the common display, the symbols in the partitioned regions selected in the plurality of slot machines are displayed to form symbol arrays. When an award is generated based on the symbol arrays, a dividend for the award is allocated to each of the slot machines.

### CROSS REFERENCE TO RELATED APPLICATIONS

This application claims priority to co-pending U.S. provisional patent application Ser. No. 61/039,661 filed on Mar. 26, 2008, and which is incorporated by reference herein for all purposes.

### BACKGROUND OF THE INVENTION

1. Field of the Invention

The present invention relates to a gaming system which includes a plurality of gaming terminals and executes a common game at each of the gaming terminals, and to a method for controlling the gaming system.

2. Description of the Related Art

Related gaming machines such as slot machines are described in U.S. Pat. No. 5,820,459 specification, U.S. Pat. No. 6,695,697 specification, U.S. Patent Application Publication No. 2003/0,069,073 specification, European Patent Application Publication No. 1,192,975 specification, U.S. Pat. No. 6,254,483 specification, U.S. Pat. No. 5,611,730 specification, U.S. Pat. No. 5,639,088 specification, U.S. Pat. No. 6,257,981 specification, U.S. Pat. No. 6,234,896 specification, U.S. Pat. No. 6,001,016 specification, U.S. Pat. No. 6,273,820 specification, U.S. Pat. No. 6,224,482 specification, U.S. Pat. No. 4,669,731 specification, U.S. Pat. No. 6,244,957 specification, U.S. Pat. No. 5,910,048 specification, U.S. Pat. No. 5,695,402 specification, U.S. Pat. No. 6,003,013 specification, U.S. Pat. No. 4,283,709 specification, European Patent Application Publication No. 0,631,798 specification, German Patent Application Publication No. 4,137,010 specification, British Patent Application Publication No. 2,326,830 specification, German Patent Application Publication No. 3,712,841 specification, U.S. Pat. No. 4,964,638 specification, U.S. Pat. No. 6,089,980 specification, U.S. Pat. No. 5,280,909 specification, U.S. Pat. No. 5,702,303 specification, U.S. Pat. No. 6,270,409 specification, U.S. Pat. No. 5,770,533 specification, U.S. Pat. No. 5,836,817 specification, U.S. Pat. No. 6,932,704 specification, U.S. Pat. No. 6,932,707 specification, U.S. Pat. No. 4,837,728 specification, European Patent Application Publication No. 1,302,914 specification, U.S. Pat. No. 4,624,459 specification, U.S. Pat. No. 5,564,700 specification, PCT Patent Application Publication No. 03/083,795 specification, German Patent Application Publication No. 3,242,890 specification, European Patent Application Publication No. 0,840,264 specification, German Patent Application Publication No. 10,049,444 specification, PCT patent application Ser. No. 04/095,383 specification, European Patent Application Publication No. 1,544,811 specification, U.S. Pat. No. 5,890,963 specification, European Patent Application Publication No. 1,477,947 specification, and European Patent Application Publication No. 1,351,180 specification.

In a facility having such a gaming machine installed therein, a player can play a game provided by the gaming machine by placing a wager such as coins or credits in the gaming machine.

For example, every time the player places a wager in a slot machine that is an example of the gaming machine, and presses a start switch, the slot machine executes a slot game in which a plurality of symbols arranged on a display are rearranged. Thereafter, when a combination of the symbols rearranged on the display corresponds to a predetermined winning combination, the slot machine provides an award corresponding to the winning combination.

Furthermore, the slot machine also provides a jackpot (progressive bonus). Specifically, the slot machine accumulates a part of the wagers, such as coins or credits, which are placed in the slot machine, as a jackpot wager. Moreover, the slot machine determines, at a predetermined timing, whether or not to provide an award corresponding to the jackpot wager. Thereafter, when it is determined that the award is to be provided, an award corresponding to all of or a part of the jackpot wager accumulated is provided to the player.

However, the conventional gaming machine as described above provides an award corresponding to the jackpot wager only when the jackpot is won. Thus, there has been desired the advent of a gaming system having new entertainment properties.

### SUMMARY OF THE INVENTION

A first aspect of the present invention is a gaming system comprising: a plurality of gaming terminals; a center controller connected to each of the gaming terminals; and a common display connected to the center controller, wherein each of the gaming terminals includes a terminal display having a plurality of display regions with symbols being arranged in the display regions, the display regions being divided into a plurality of partitioned regions, and a terminal controller configured to (a) execute a slot game to rearrange the symbols in the display regions upon receipt of a bet, (b) generate a first award corresponding to a combination of the rearranged symbols, and (c) select one of the partitioned regions upon receipt of an external input, and wherein the center controller is configured to form a symbol array by displaying on the common display the symbols rearranged in the display regions included in the partitioned regions selected by the gaming terminals upon a predetermined condition, and upon generation of a second award based on the symbol array, distribute a dividend for the second award to each of the gaming terminals.

A second aspect of the present invention is a gaming system comprising: a plurality of gaming terminals; a center controller connected to each of the gaming terminals; and a common display connected to the center controller, wherein each of the gaming terminals includes an operation switch operable by a player, a terminal display having a plurality of display regions with symbols being arranged in the display regions, the display regions being divided into a plurality of partitioned regions, and a terminal controller configured to (a) execute a slot game to rearrange the symbols in the display regions upon receipt of a bet, (b) generate a first award corresponding to a combination of the rearranged symbols, (c) upon a predetermined condition, receive an operation input from the operation switch and scroll lighting of a display frame surrounding one of the respective partitioned regions through the respective partitioned regions, and (d) stop the scrolling of the lighting of the display frame when the operation switch is operated and select the partitioned region surrounded by the lighting of the display frame when the scrolling is stopped, and wherein the center controller is configured to form a symbol array by displaying on the common display the symbols rearranged in the display regions included in the partitioned regions selected by the gaming terminals upon the predetermined condition, and upon generation of a second award based on the symbol array, distribute a dividend for the second award to each of the gaming terminals.

A third aspect of the present invention is a gaming system comprising: a plurality of gaming terminals; a center controller connected to each of the gaming terminals; and a common display connected to the center controller, wherein each of the gaming terminals includes a terminal display having a plurality of display regions with symbols being arranged in the display regions, the display regions being divided into a plurality of partitioned regions, a progressive bonus counter configured to count a progressive bonus count value, and a terminal controller configured to (a) execute a slot game to rearrange the symbols in the display regions upon receipt of a bet, (b) accumulate a part of the bet in the progressive bonus counter as a cumulative count value, (c) generate a first award corresponding to a combination of the rearranged symbols, and (d) select one of the partitioned regions upon receipt of an external input, wherein the center controller is configured to, upon a predetermined condition, form a symbol array by displaying on the common display the symbols rearranged in the display regions included in the partitioned regions selected by the gaming terminals and determine whether or not a second award based on the symbol array is generated, and wherein the gaming terminal is configured to generate a part of or all of an amount corresponding to the cumulative count value in the progressive bonus counter as a dividend for the second award upon generation of the second award.

A fourth aspect of the present invention is a method for controlling a gaming system, the method comprising: executing slot games in a plurality of gaming terminals; upon a predetermined condition, forming a symbol array by displaying on a common display, among symbols displayed in display regions as outcomes of the slot games executed in the gaming terminals, the symbols in the display regions included in partitioned regions selected at the gaming terminals, one partitioned region being selected at each of the gaming terminals by an operation of an operation switch; and upon generation of an award based on the symbol array, distributing a dividend for the award to each of the gaming terminals.

### BRIEF DESCRIPTION OF THE DRAWINGS

FIG. 1 is a view showing display examples of terminal displays and a common display when a common game is executed in a gaming system according to first to third embodiments of the present invention.

FIG. 2 is a configuration diagram showing an entire gaming system according to the first to third embodiments of the present invention.

FIG. 3 is a network connection diagram of the gaming system according to the first to third embodiments of the present invention.

FIG. 4 is a configuration diagram showing an entire slot machine used in the gaming system according to the first embodiment of the present invention.

FIG. 5 is a block diagram showing an electrical configuration of the slot machine used in the gaming system according to the first embodiment of the present invention.

FIG. 6 is a block diagram showing an electrical configuration of a center controller used in the gaming system according to the first embodiment of the present invention.

FIG. 7 is a view showing a payout table for a slot game executed in the slot machine according to the first to third embodiments of the present invention.

FIG. 8 is a flowchart showing slot game execution processing according to the first embodiment of the present invention.

FIG. 9 is a flowchart showing the slot game execution processing according to the first embodiment of the present invention.

FIG. 10 is a flowchart showing common game execution processing according to the first embodiment of the present invention.

FIG. 11 is a flowchart showing bonus game execution processing according to the first embodiment of the present invention.

FIG. 12 is a flowchart showing display region selection processing according to the first embodiment of the present invention.

FIG. 13 is a flowchart showing payout processing according to the first embodiment of the present invention.

FIG. 14 is a flowchart showing another display region selection processing according to the first embodiment of the present invention.

FIG. 15 is a flowchart showing still another display region selection processing according to the first embodiment of the present invention.

FIG. 16 is an explanatory view showing a display example of a terminal display in the gaming system according to the first embodiment of the present invention.

FIG. 17 is an explanatory view showing a display example of the terminal display in the gaming system according to the first embodiment of the present invention.

FIG. 18 is an explanatory view showing a display example of the terminal display in the gaming system according to the first embodiment of the present invention.

FIG. 19 is a block diagram showing an electrical configuration of a center controller used in a gaming system according to the second embodiment of the present invention.

FIG. 20 is a flowchart showing slot game execution processing according to the second embodiment of the present invention.

FIG. 21 is a flowchart showing the slot game execution processing according to the second embodiment of the present invention.

FIG. 22 is an explanatory view showing a display example of a terminal display in the gaming system according to the second embodiment of the present invention.

FIG. 23 is a block diagram showing an electrical configuration of a slot machine used in a gaming system according to the third embodiment of the present invention.

FIG. 24 is a flowchart showing slot game execution processing according to the third embodiment of the present invention.

FIG. 25 is a flowchart showing the slot game execution processing according to the third embodiment of the present invention.

FIG. 26 is a flowchart showing payout processing according to the third embodiment of the present invention.

FIG. 27 is an explanatory view showing a display example of a terminal display in the gaming system according to the third embodiment of the present invention.

FIG. 28 is a configuration diagram showing an entire gaming system according to a fourth embodiment of the present invention.

FIG. 29 is a network connection diagram of the gaming system according to the fourth embodiment of the present invention.

FIG. 30 is an explanatory view showing paylines in a slot machine according to the fourth embodiment of the present invention.

FIG. 31 is a view showing a payout table for a slot game executed in the slot machine according to the fourth embodiment of the present invention.

FIG. 32 is a flowchart showing display region selection processing according to the fourth embodiment of the present invention.

FIG. 33 is an explanatory view showing a display example of a terminal display in the gaming system according to the fourth embodiment of the present invention.

FIG. 34 is an explanatory view showing a display example of the terminal display in the gaming system according to the fourth embodiment of the present invention.

FIG. 35 is an explanatory view showing a display example of the terminal display in the gaming system according to the fourth embodiment of the present invention.

FIG. 36 is an explanatory view showing a display example of the terminal display in the gaming system according to the fourth embodiment of the present invention.

FIG. 37 is an explanatory view showing a display example of the terminal display in the gaming system according to the fourth embodiment of the present invention.

FIG. 38 is an explanatory view showing a display example of a common display in the gaming system according to the fourth embodiment of the present invention.

### DETAILED DESCRIPTION OF THE EMBODIMENT

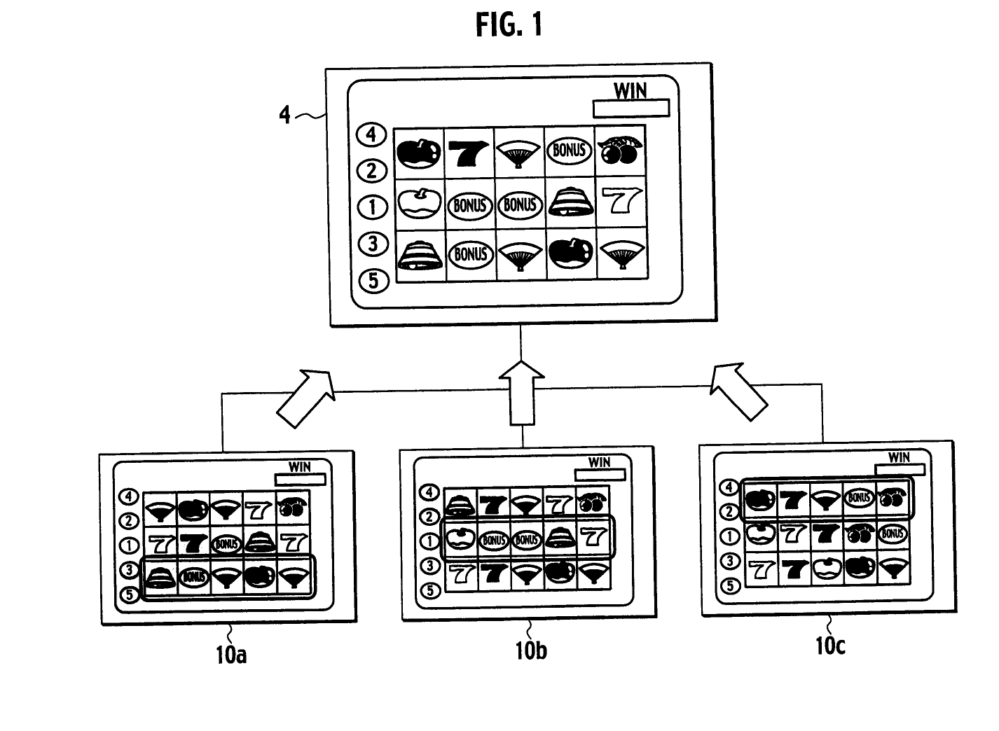

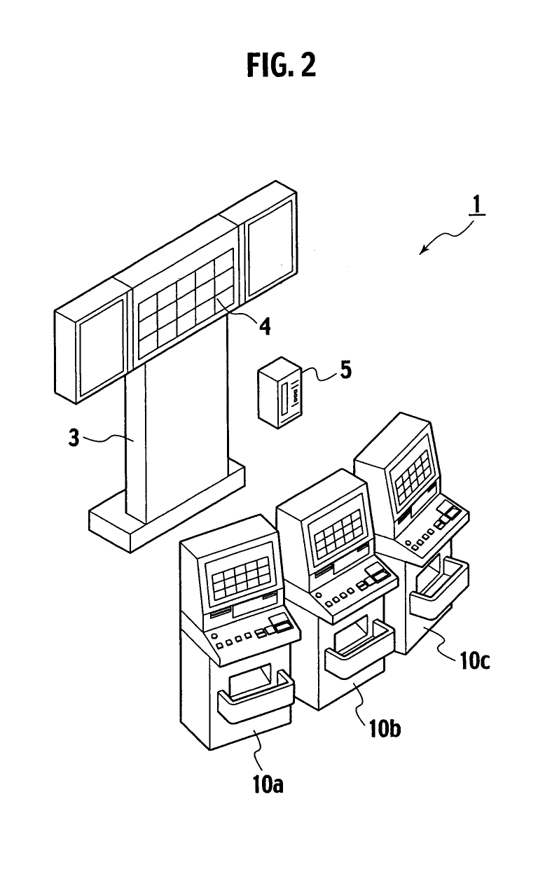

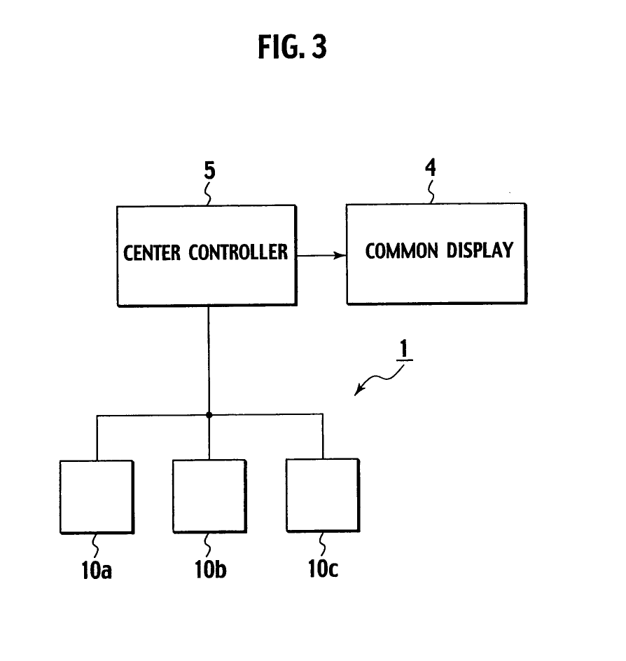

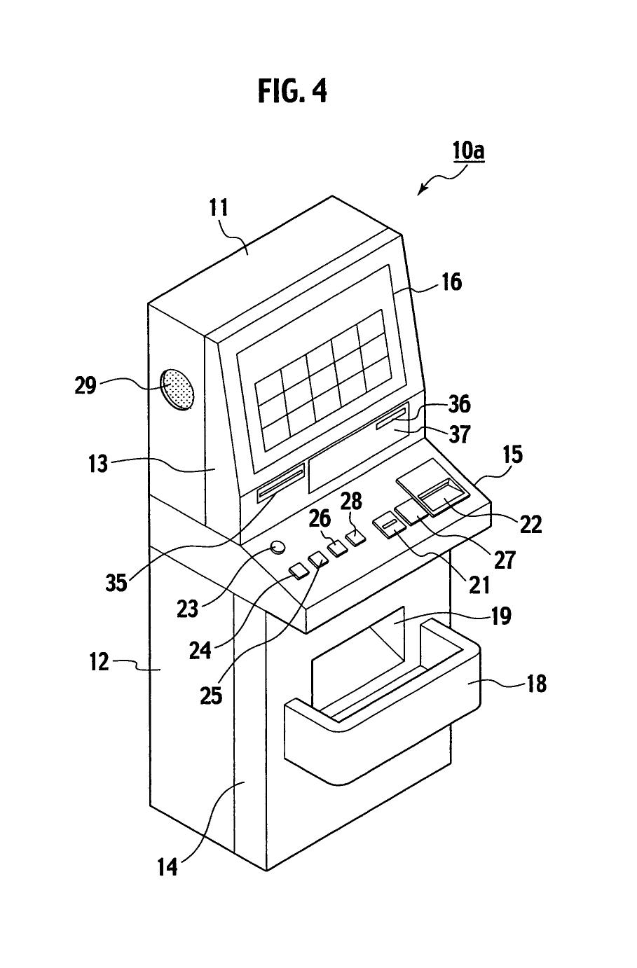

FIG. 1 is an explanatory view showing symbol display examples displayed on a terminal display 16 (see FIG. 4) and a common display 4 (see FIG. 2) in a gaming system 1 according to first to third embodiments of the present invention. FIG. 2 is a configuration diagram showing the entire gaming system 1. FIG. 3 is a network connection diagram of the gaming system. With reference to FIGS. 1 to 3, the gaming system according to the first to third embodiments of the present invention will be schematically described below.

In the gaming system according to the first to third embodiments of the present invention, when slot games are executed, respectively, in three slot machines (gaming terminals) 10a, 10b and 10c as shown in FIG. 2 and a common game execution determination is made (predetermined conditions are satisfied) in a center controller 5, a common game, which is common to the slot machines 10a to 10c, is executed.

In the common game, some of symbols stopped in a total of fifteen display regions arranged in three rows and five columns, which are provided on a display (terminal display) 16 in each of the slot machines 10a to 10c, are displayed on the common display 4 to form symbol arrays. Suppose a case where the fifteen display regions are divided into three partitioned regions in the first (upper), second (middle) and third (lower) rows. When the partitioned region in the third row is selected in the slot machine 10a, the partitioned region in the second row is selected in the slot machine 10b and the partitioned region in the first row is selected in the slot machine 10c, symbol arrays formed of the symbols stopped in the respective partitioned regions are displayed on the common display 4. The partitioned region is selected by an operation performed by the players of the respective slot machines 10a to 10c.

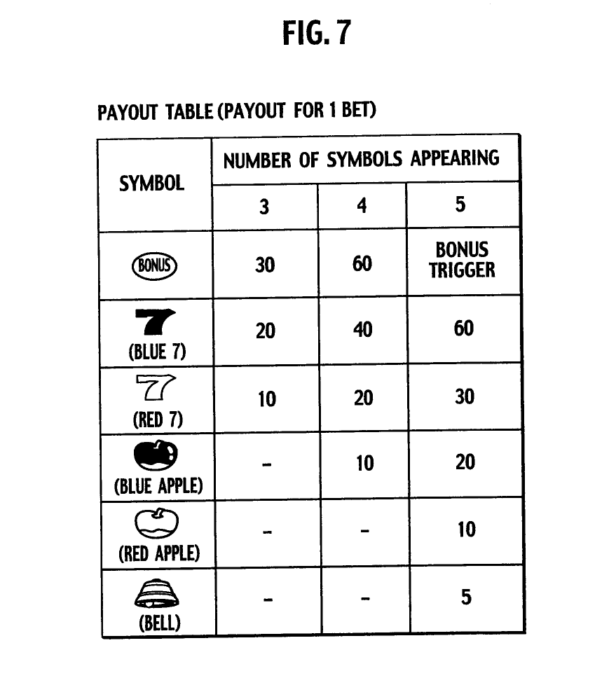

The center controller 5 determines whether or not an award (a second award) is generated based on the symbol arrays displayed on the common display 4. For example, since four “BONUS” symbols are displayed on the common display 4 shown in FIG. 1, a payout (a second award) for 60 medals is generated (see FIG. 7). Therefore, this payout is allocated and distributed per 20 medals each to the respective slot machines 10a to 10c as a dividend.

As described above, in the gaming system according to the first to third embodiments of the present invention, when the common game execution determination is made in the center controller 5, one of the partitioned regions is selected from each of the slot machines 10a to 10c by the operation of the players. The symbols in the partitioned region thus selected are then displayed on the common display 4. Thereafter, when an award is generated based on the symbol arrays displayed on the common display 4, a payout (a dividend) corresponding to the award is allocated and distributed to the slot machines 10a to 10c. Therefore, the execution of the common game in which multiple slot machines 10a to 10c participate enables to enhance the expectations of the players that an award is generated. Thus, the gaming system having excellent entertainment properties can be provided.

Next, the gaming system 1 according to the first embodiment will be described in detail. As shown in FIG. 2, the gaming system 1 according to the first embodiment includes: the common display 4 provided on a supporting member 3; a plurality of slot machines (3 slot machines in FIG. 2) 10a to 10c disposed in front of the common display 4; and the center controller 5 configured to perform overall control of the slot machines 10a to 10c as well as to perform display control of the common display 4.

Each of the slot machines 10a to 10c is configured to allow the player to execute the slot game. As described later, when the common game execution determination is made (predetermined conditions are satisfied) in the center controller 5, the common game is executed.

FIG. 3 is a network connection diagram of the gaming system 1 according to this embodiment. As shown in FIG. 3, the three slot machines 10a to 10c are connected to the center controller 5 via a network. Furthermore, the center controller 5 is connected to the common display 4.

Next, with reference to FIG. 4, a configuration of each of the slot machines 10 will be described. Note that, since the slot machines 10a to 10c have the same configuration, description will be given by taking the slot machine 10a as an example. As shown in FIG. 4, the slot machine 10a according to this embodiment includes an upper cabinet 11, a lower cabinet 12 and a console 15 provided so as to protrude forward between the upper and lower cabinets 11 and 12.

An upper door 13 is attached to the upper cabinet 11 so as to be openable and closable by use of a hinge (not shown). Similarly, a lower door 14 is attached to the lower cabinet 12 so as to be openable and closable by use of a hinge (not shown). In a normal operation, the slot game is executed in a state where the upper and lower doors 13 and 14 are closed. In the event of failure or maintenance, the doors are opened and closed by a manager who owns an exclusive key.

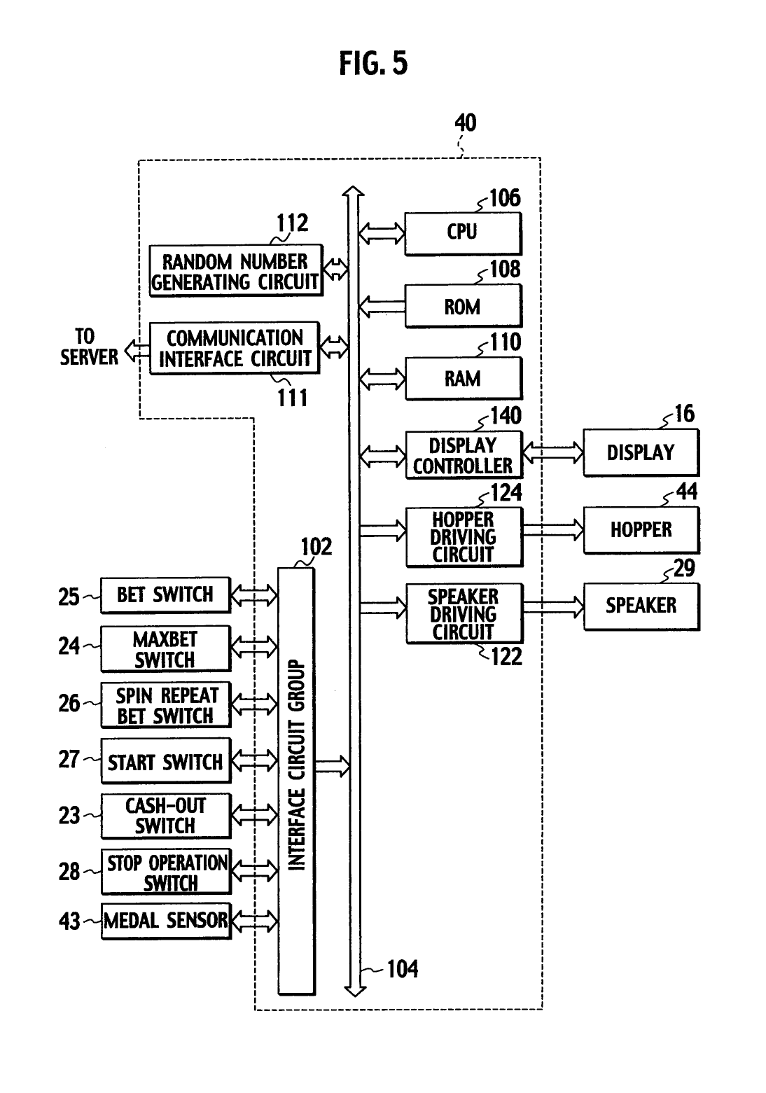

Moreover, inside the upper cabinet 11, various constituent members are provided, including a controller 40 (see FIG. 5) for electrically controlling the slot machine 10, a hopper 44 (see FIG. 5) for controlling insertion, storage and payout of medals, and the like. Furthermore, on a side of the upper cabinet 11, a speaker 29 for outputting sound effects associated with execution of the slot game is provided.

On a front surface of the upper door 13, the surface facing the player, the display 16 is provided. The display 16 displays images related to games. Specifically, in the slot machine 10a used in this embodiment, a total of fifteen symbols arranged in three rows and five columns are displayed. Moreover, the respective symbols start being scrolled when the slot game is executed, and stop being scrolled after elapse of a predetermined time. Thereafter, whether or not an award is generated is determined depending on combinations of the symbols stopped. When the award is generated, a predetermined number of the payout of medals is provided. Moreover, on the display 16, various effect images besides the above symbols are displayed in the course of the slot game.

Moreover, below the display 16, a ticket printer 35, a card reader 36 and a data display 37 are provided.

The ticket printer 35 prints out a bar-code on a ticket, the bar-code having coded data such as the number of credits, time, date and an identification number of the slot machine 10a, and outputs the ticket as a bar-coded ticket. The player can play a game with another slot machine by allowing the slot machine to read the bar-coded ticket or can exchange the bar-coded ticket for bills and the like at a predetermined location in a gaming facility (for example, a cashier in a casino).

The card reader 36 allows a smart card to be inserted thereinto, reads data from the smart card thus inserted and writes data into the smart card. The smart card, a card carried by the player, stores such data for identifying the player, or data on a gaming record played by the player.

The data display 37 displays various data related to the slot game. For example, data on gaming record, on the number of credits, on the number of payouts and the like are displayed on the data display 37.

Note that, in this embodiment, medals are taken as an example of wagers used for executing a game. However, the wagers are not limited to the medals but may include, for example, coins, tokens, electronic money and valuable electronic information (credits) equivalent thereto.

Moreover, on the console 15, a cash-out switch 23, a MAX bet switch 24, a bet switch 25, a spin repeat bet switch 26, a start switch 27 and a stop operation switch 28 are provided. Furthermore, on the console 15, provided are: a medal insertion slot 21 into which medals used for playing a game are inserted; and a bill validator 22 for validating whether or not bills are legitimate and for accepting the legitimate bills.

The cash-out switch 23 is a switch for a payout of the inserted medals. The medals to be paid out are discharged from a medal payout opening 19 provided in a front face of the lower door 14. The medals paid out are accumulated in a medal tray 18.

The MAX bet switch 24 is a switch for betting, in one operation, the maximum number of credits (for example, 30 medals) that can be bet on one slot game. Note that the maximum number of credits that can be bet on one slot game is changeable by an operation of the manager. For example, the slot machine can also be set so as to enable a bet of up to 50 medals.

The bet switch 25 is a switch for determining the number of credits to be bet on a slot game executed on the display 16. Every time the bet switch 25 is pressed, a credit for 1 medal is bet.

The spin repeat bet switch 26 is a switch for executing a slot game by betting credits without changing the number of credits bet via the bet switch 25 described above in the previous slot game.

The start switch 27 is a switch for starting a slot game on the display 16 after the credits are bet. When the start switch 27 is pressed after medals are inserted into the medal insertion slot 21 or credits are bet via the bet switch 25, the slot game is started, in which symbols are scrolled and then stopped in the respective display regions arranged in three rows and five columns on the display 16.

The stop operation switch 28 is a switch for arbitrarily selecting certain partitioned regions set on the display 16 at the time of selecting partitioned region to be described later.

FIG. 5 is a block diagram showing an electrical configuration of the controller (terminal controller) 40 and various devices connected to the controller 40, controller and the devices being provided in the slot machine 10a according to this embodiment. The controller 40 shown in FIG. 5 is a microcomputer, including an interface circuit group 102, an I/O bus 104, a CPU 106, a ROM 108, a RAM 110, a communication interface circuit 111, a random number generating circuit 112, a speaker driving circuit 122, a hopper driving circuit 124 and a display controller 140.

The interface circuit group 102 is connected to the I/O bus 104. The I/O bus 104 inputs and outputs a data signal or an address signal to and from the CPU 106.

The start switch 27 is connected to the interface circuit group 102. A start signal outputted from the start switch 27 is converted into a predetermined signal by the interface circuit group 102 and then transmitted to the CPU 106 through the I/O bus 104.

The bet switch 25, the MAX bet switch 24, the spin repeat bet switch 26, the cash-out switch 23 and the stop operation switch 28 are further connected to the interface circuit group 102. Each of switching signals outputted from those switches 25, 24, 26, 23 and 28 is supplied to the interface circuit group 102, converted into a predetermined signal by the interface circuit group 102 and then transmitted to the CPU 106 through the I/O bus 104.

In addition, a medal sensor 43 is connected to the interface circuit group 102. The medal sensor 43 is a sensor for detecting medals inserted into the medal insertion slot 21 and is provided in a medal insertion part of the medal insertion slot 21. A detection signal outputted by the medal sensor 43 is supplied to the interface circuit group 102, converted into a predetermined signal by the interface circuit group 102 and then transmitted to the CPU 106 through the I/O bus 104.

The ROM 108 storing system programs and the RAM 110 for storing various data are connected to the I/O bus 104. The random number generating circuit 112, the communication interface circuit 111, the display controller 140, the hopper driving circuit 124 and the speaker driving circuit 122 are further connected to the I/O bus 104.

Upon receipt of a game start operation from the start switch 27, the CPU 106 executes a slot game by reading a game execution program. The game execution program is a program for executing a slot game on the display 16 through the display controller 140.

To be more specific, the game execution program is configured to execute the following slot game. Specifically, fifteen symbols are scrolled in the display regions on the display 16 and then the symbols stops being scrolled. When the stopped symbols form a winning combination, a payout is provided.

The communication interface circuit 111 is connected to the center controller 5 via a network and transmits to the center controller 5 data on a playing record executed in the slot machine 10a. Moreover, the communication interface circuit 111 receives various data transmitted from the center controller 5.

The random number generating circuit 112 generates a random number for determining whether or not to generate a winning combination in a slot game executed on the display 16.

The speaker driving circuit 122 outputs a sound signal to the speaker 29. Specifically, the CPU 106 reads sound data stored in the ROM 108 and transmits the sound data to the speaker driving circuit 122 through the I/O bus 104. Thus, predetermined sound effects are emitted from the speaker 29.

The hopper driving circuit 124 outputs a payout signal to the hopper 44 when a cash-out occurs. Specifically, when a cash-out signal is inputted by the cash-out switch 23, the CPU 106 outputs a driving signal to the hopper driving circuit 124 through the I/O bus 104. Thus, the hopper 44 provides payout of medals equivalent to the number of credits, remaining at the time, which is stored in a predetermined memory region of the RAM 110.

The display controller 140 performs display control for executing a slot game on the display 16. Specifically, the CPU 106 generates an image display command signal corresponding to a state of a slot game and an outcome of the slot game. The CPU then outputs the image display command signal to the display controller 140 through the I/O bus 104. Upon input of the image display command signal outputted by the CPU 106, the display controller 140 generates a driving signal for driving the display 16 followed by the image display command and then outputs the generated driving signal to the display 16. Thus, various images such as effect images and images for explaining games are displayed on the display 16. Furthermore, the display controller 140 performs display control of the data display 37.

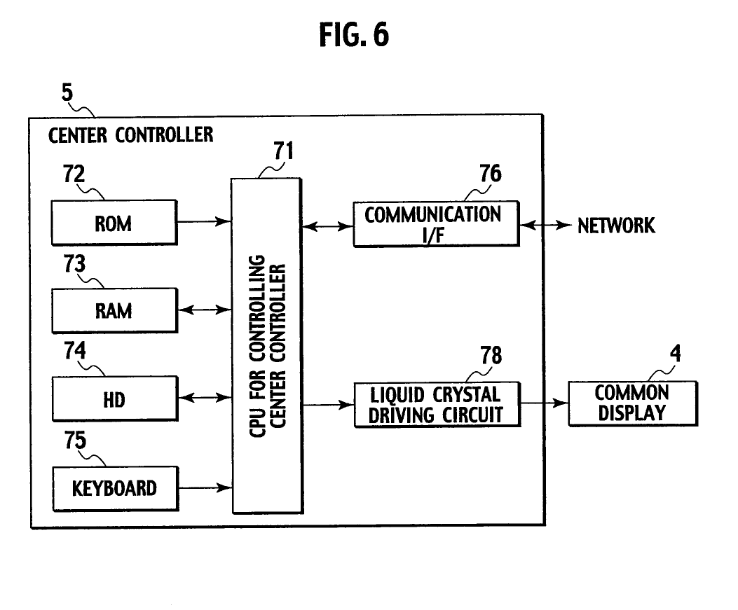

Next, with reference to a block diagram shown in FIG. 6, an electrical configuration of the center controller 5 will be described. As shown in FIG. 6, the center controller 5 includes: a CPU 71 for controlling the center controller, which performs overall control of the slot game; a ROM 72; a RAM 73; a hard disk 74 storing programs and various data such as image data to be displayed on the common display 4; a keyboard 75 which receives an operation input by the manager; a communication I/F 76 which communicates with each of the slot machines 10a to 10c via the network; and a liquid crystal driving circuit 78 which performs display control of the common display 4.

The CPU 71 for controlling the center controller determines whether or not to execute a common game. When it is determined that the common game is to be executed (when predetermined conditions are met), the CPU 71 for controlling the center controller executes the common game. Specifically, in the common game, some of the symbols displayed on the display 16 in each of the slot machines 10a to 10c are displayed on the common display 4 to form a symbol array. Thereafter, it is determined whether or not an award is generated based on the symbol array. A common game execution determination is made, for example, after a predetermined time passes or at a random timing.

Next, with reference to FIG. 7, description will be given of a payout in a slot game to be executed in each of the slot machines 10a to 10c. FIG. 7 shows a payout table showing a relationship between payouts and symbols to be displayed in a total of fifteen display regions arranged in three rows and five columns, which are set on the display 16 in each of the slot machines 10a to 10c.

As shown in FIG. 7, each of the display regions displays any symbol among a “BONUS” symbol, a “BLUE 7” symbol, a “RED 7” symbol, a “BLUE APPLE” symbol, a “RED APPLE” symbol, a “BELL” symbol, a “CHERRY” symbol and a “FAN” symbol (see FIG. 1). Note that the “FAN” symbol is not set to be a scatter symbol and thus is not shown in the payout table of FIG. 7.

Moreover, as shown in FIG. 7, the payout of 20 medals is provided for 1 bet when three “BLUE 7” symbols appear in the corresponding display regions out of 15 regions on the display 16, the payout of 40 medals is provided for 1 bet when four “BLUE 7” symbols appear therein, and the payout of 60 medals is provided for 1 bet when five “BLUE 7” symbols appear therein. Moreover, the payout of 30 medals is provided for 1 bet when three “BONUS” symbols appear in the corresponding display regions out of 15 regions on the display 16, the payout of 60 medals is provided for 1 bet when four “BONUS” symbols appear therein, and a bonus trigger is formed when five “BONUS” symbols appear therein. When the bonus trigger is formed, a bonus game is executed. The bonus game will be described in detail later.

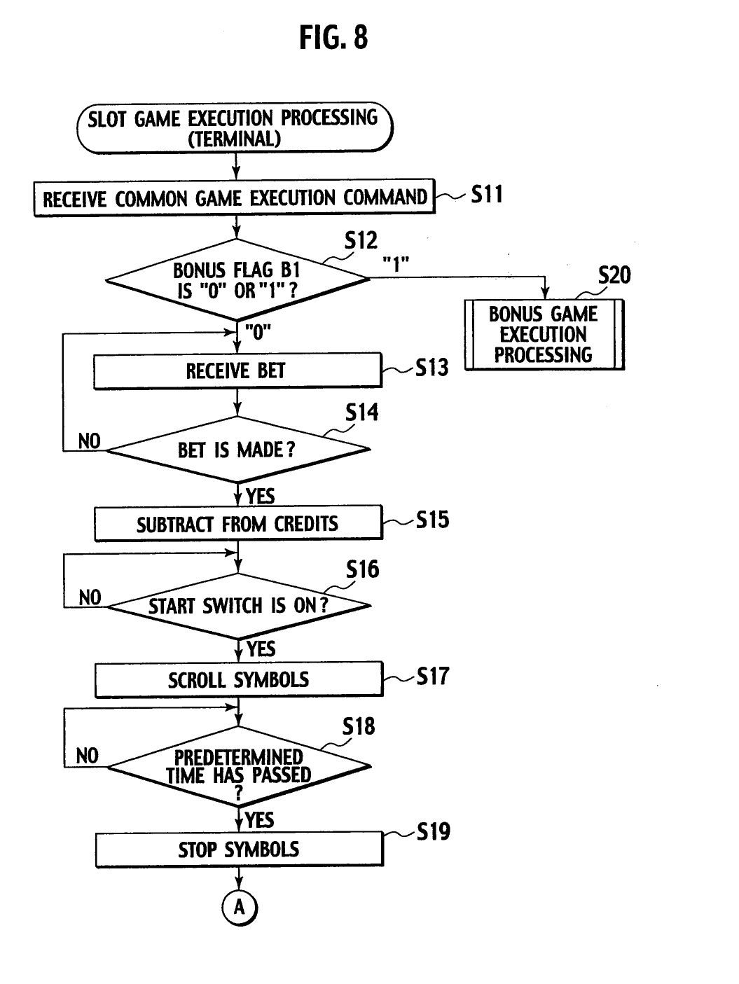

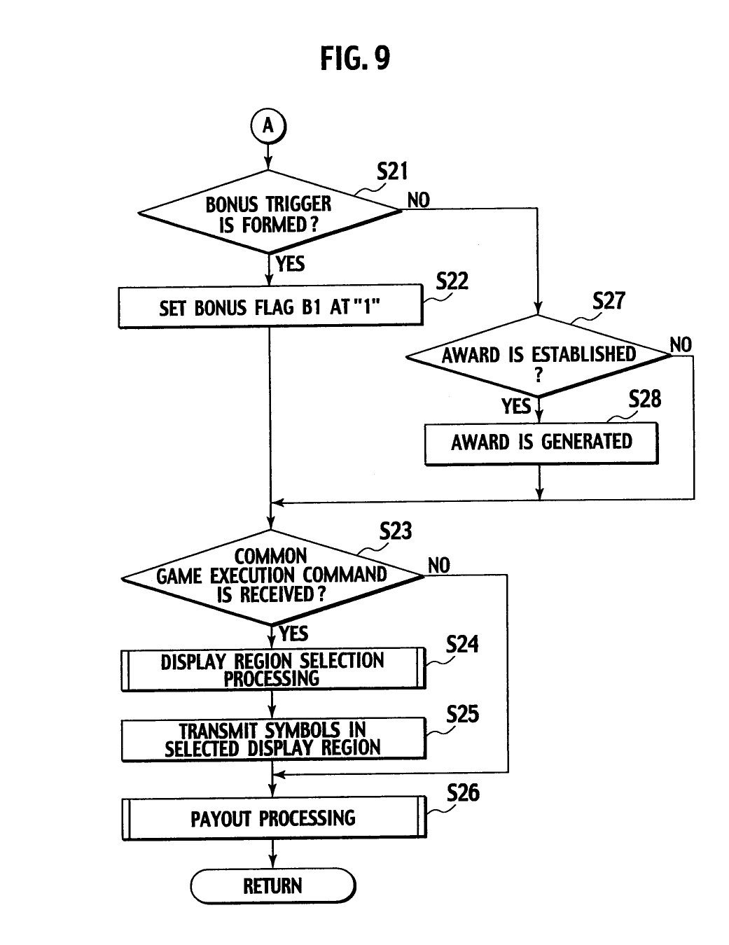

Next, with reference to flowcharts shown in FIGS. 8 and 9, description will be given of slot game execution processing performed by each of the slot machines 10a to 10c in the gaming system 1 according to the first embodiment of the present invention. Since the slot machines 10a to 10c perform the same slot game execution processing, description will be given only for the slot game execution processing performed by the slot machine 10a.

The controller 40 shown in FIG. 5 receives a common game execution command (Step S11). In this step, the controller 40 receives a common game execution command transmitted by the center controller 5 when the common game execution determination is made in the center controller 5 to execute a common game, which is common to the slot machines 10a to 10c.

Next, the controller 40 determines whether a bonus flag B1 is “0” or “1” (Step S12). The bonus flag B1 is a flag which is set to “1” when a bonus trigger to be described later is formed and is set to “0” when a bonus game is finished. The bonus flag B1 is stored in the RAM 110 shown in FIG. 5. Note that the bonus flag B1 is initially set to “0”.

When the bonus flag B1 is “1”, the controller 40 moves to bonus game execution processing (Step S20). The bonus game execution processing will be described in detail later.

When the bonus flag B1 is “0”, the controller 40 receives a bet operation performed by the player (Step S13). Specifically, the controller 40 receives a bet operation performed when medals are inserted into the medal insertion slot 21 or when any of the MAX bet switch 24, the bet switch 25 and the spin repeat bet switch 26 are pressed.

When a bet is made (YES in Step S14), the controller 40 performs credit subtraction processing. Specifically, the controller 40 performs processing of subtracting the number of credits bet from the current number of credits (Step S15).

Thereafter, the controller 40 determines whether or not the start switch 27 is turned on (Step S16). When the start switch 27 is turned on (YES in Step S16), fifteen symbols displayed on the display 16 starts being scrolled (Step S17).

Subsequently, the controller 40 determines whether or not a predetermined time (for example, 5 seconds) has passed since the symbols start being scrolled (Step S18). When the predetermined time has passed (YES in Step S18), the symbols stops being scrolled (Step S19).

Thereafter, the controller 40 determines whether or not a bonus trigger is formed in the fifteen symbols stopped (Step S21). To be more specific, the controller 40 determines whether or not five “BONUS” symbols appear as shown in FIG. 7. When five “BONUS” symbols appear (YES in Step S21), the controller 40 sets the bonus flag B1 to “1” (Step S22).

On the other hand, when no bonus trigger is formed, in other words, five “BONUS” symbols do not appear (NO in Step S21), the controller 40 determines whether or not an award (a first award) is established based on the fifteen symbols stopped. Specifically, the controller 40 determines whether or not any one of awards listed in the payout table shown in FIG. 7 is established (Step S27). When the award is established (YES in Step S27), the controller 40 generates the award (the first award) corresponding to the symbol combination (Step S28).

Thereafter, the controller 40 determines whether or not the common game execution command transmitted by the center controller 5 is received (Step S23). Specifically, the controller 40 determines whether or not the common game execution command has been received in Step S11 shown in FIG. 8.

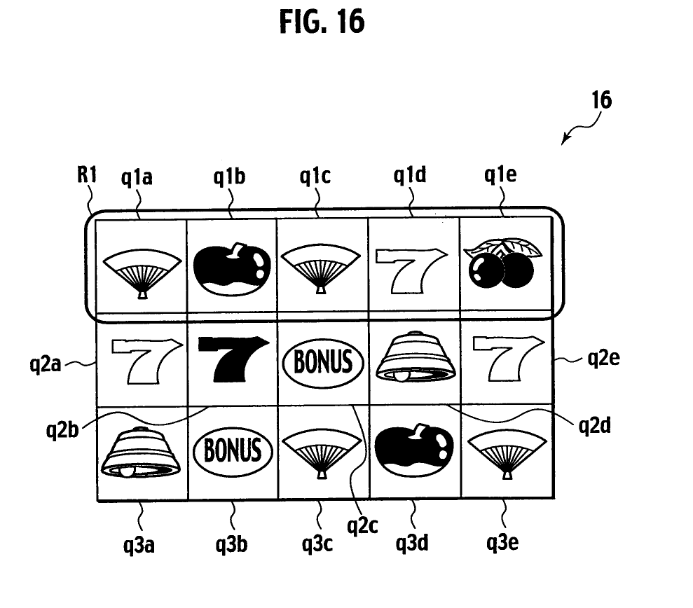

When the common game execution command is received (YES in Step S23), the controller 40 executes display region selection processing (Step S24). In the display region selection processing, any one of partitioned regions (R1, R2 and R3 shown in FIGS. 16 to 18), which are set in the total of fifteen display regions arranged in three rows and five columns, is selected. The display region selection processing will be described in detail later.

The controller 40 transmits data on the symbols displayed in the partitioned region selected by the display region selection processing in Step S24 to the center controller 5 (Step S25). In response, the center controller 5 forms symbol arrays based on the symbol data transmitted from each of the slot machines 10a to 10c and displays the symbol arrays on the common display 4.

The controller 40 executes payout processing on the award (the first award) generated in Step S28 and a dividend (for the second award) based on a dividend command transmitted from the center controller 5 (Step S26). The payout processing will be described in detail later. Thus, the slot game execution processing is completed.

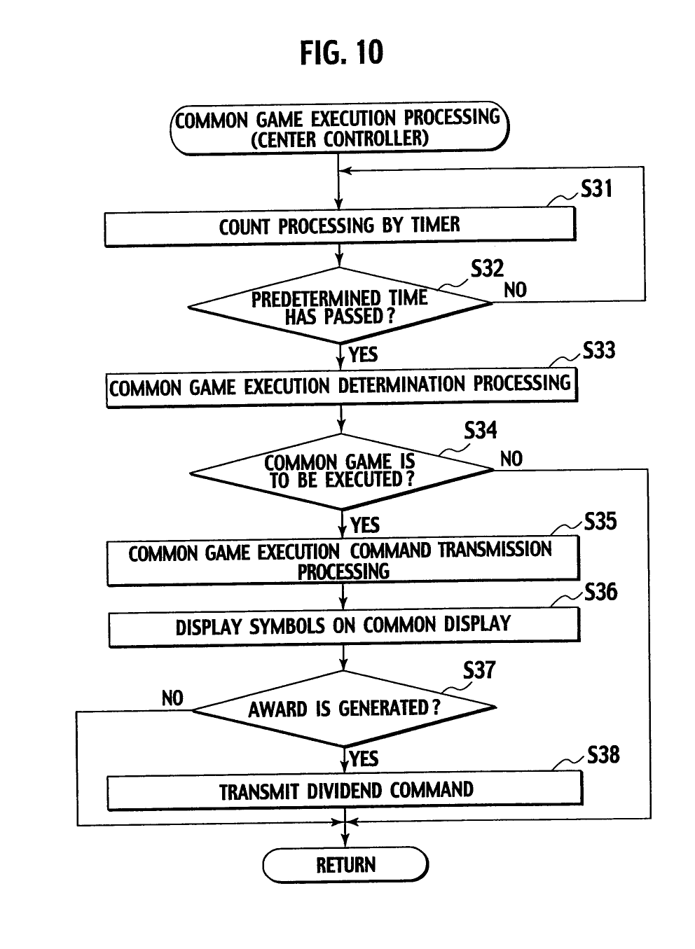

Next, with reference to a flowchart shown in FIG. 10, description will be given of common game execution processing to be performed by the center controller 5.

The CPU 71 for controlling the center controller shown in FIG. 6 executes timing processing by use of a timer (Step S31). Here, the timer is set in the RAM 73 shown in FIG. 6.

The CPU 71 for controlling the center controller determines whether or not time shown on the timer has reached a predetermined time (Step S32). When the predetermined time has passed, the CPU 71 for controlling the center controller performs common game execution determination processing (Step S33). In this common game execution determination processing, whether or not to execute a common game is randomly determined.

When it is determined that the common game is to be executed (YES in Step S34), the CPU 71 for controlling the center controller transmits a common game execution command to each of the slot machines 10a to 10c (Step S35). The transmitted common game execution command is received by each of the slot machines 10a to 10c in Step S11 shown in FIG. 8.

The CPU 71 for controlling the center controller receives the symbols in the partitioned regions, which are transmitted from each of the slot machines 10a to 10c, on the common display 4, and displays the symbols on the common display 4 to form symbol arrays (Step S36). As a result, for example, as shown in FIG. 1, symbol arrays including a total of fifteen symbols arranged in three rows and five columns are displayed on the common display 4.

Thereafter, the CPU 71 for controlling the center controller determines whether or not any award (second award) is generated based on the symbol arrays (Step S37). Whether or not any award is generated is determined according to the payout table shown in FIG. 7. For example, since the fifteen symbols displayed on the common display 4 shown in FIG. 1 include four “BONUS” symbols, the award of 60 medals is generated.

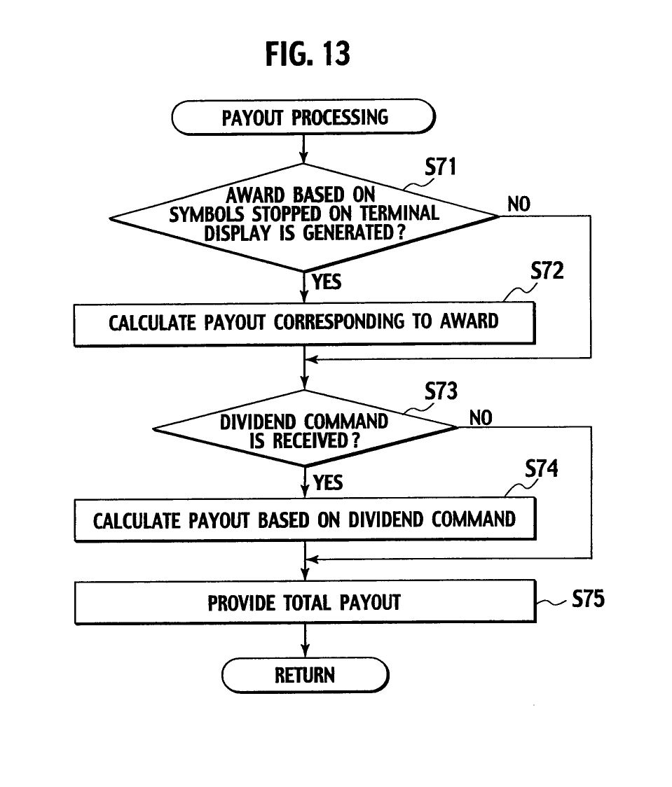

When an award is generated (YES in Step S37), the CPU 71 for controlling the center controller transmits a dividend command to each of the slot machines 10a to 10c (Step S38). The transmitted dividend command is received by each of the slot machines 10a to 10c in Step S73 shown in FIG. 13 to be described later.

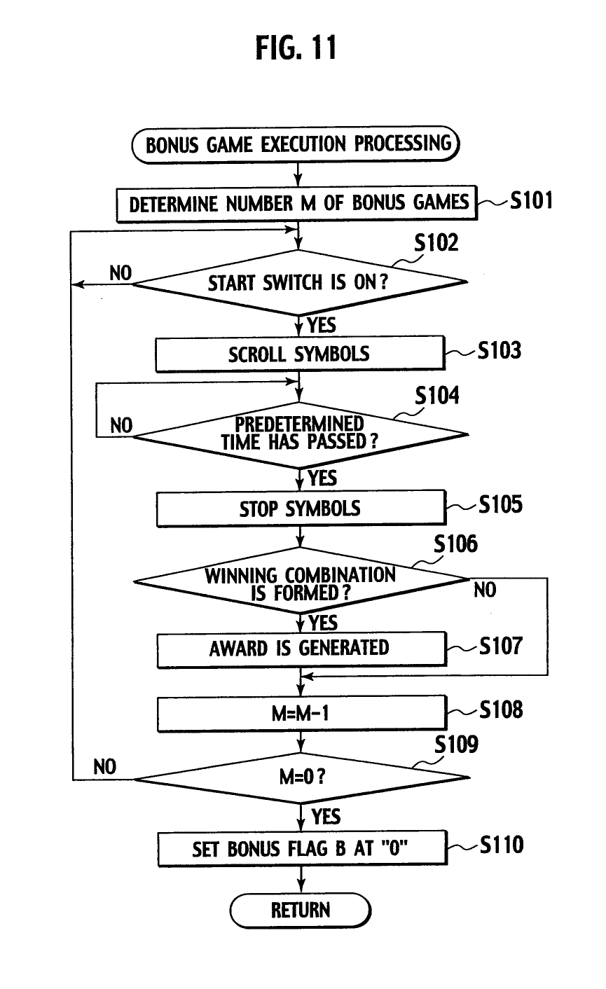

Next, with reference to FIG. 11, description will be given of the bonus game execution processing in Step S20 shown in FIG. 8.

First, the controller 40 determines the number M of bonus games (Step S101). The number M of bonus games is randomly set, for example, from among 10 games, 20 games, 30 games and 50 games. Moreover, the number M of bonus games may be always set to be the same number of games (for example, 30 games).

Next, the controller 40 determines whether or not the start switch 27 is pressed (Step S102). When the start switch 27 is pressed (YES in Step S102), the controller 40 starts scrolling the symbols on the display 16 (Step S103).

Thereafter, the controller 40 determines whether or not a predetermined time has passed (Step S104). When the predetermined time has passed (YES in Step S104), the symbols stops being scrolled (Step S105). As a result, for example, as shown in FIG. 16, various sorts of symbols stop at each of the display regions among the fifteen regions.

Subsequently, the controller 40 determines whether or not any winning combination is formed in the symbols stopped in the respective display regions (Step S106). When a winning combination is formed, in other words, the symbols set in the payout table shown in FIG. 7 appear (YES in Step S106), the controller 40 generates an award (Step S107).

Thereafter, the controller 40 decrements the number M of bonus games, in other words, sets M=M−1 (Step S108).

Subsequently, the controller 40 determines whether or not the number of bonus games M=0 (Step S109). When M is not 0, in other words, all of M times of bonus games are not finished (NO in Step S109), the controller 40 returns to Step S102. On the other hand, when M=0 (YES in Step S109), the controller 40 sets the bonus flag B1 to “0” and terminates the bonus game execution processing.

When a bonus trigger is formed as a result of the slot game execution described above, M times of bonus games are executed. In this bonus game, the player is not required to make a bet. Thus, the player can expect to obtain more payouts without losing medals and credits.

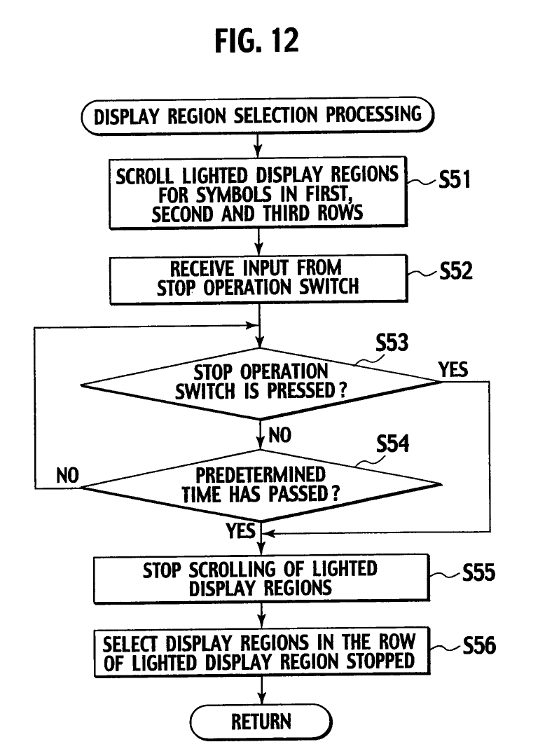

Next, with reference to FIG. 12, description will be given of the display region selection processing in Step S24 shown in FIG. 9.

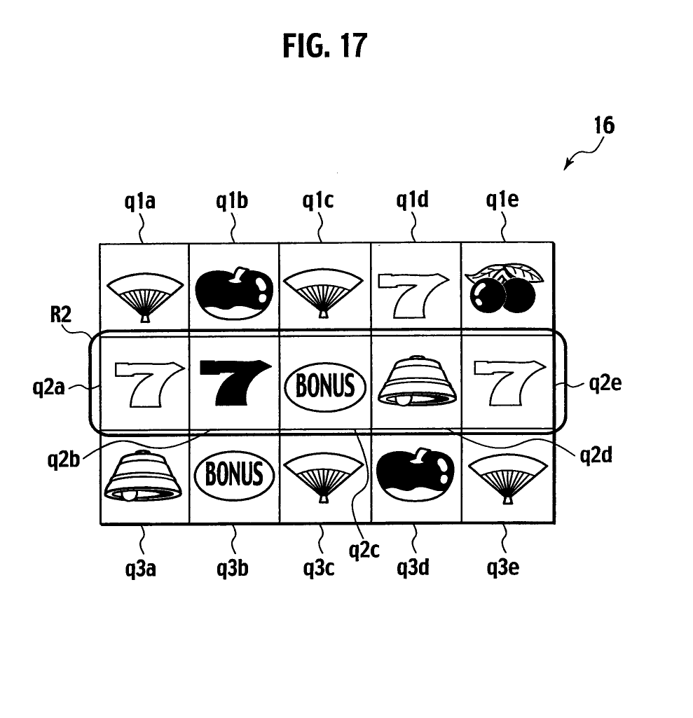

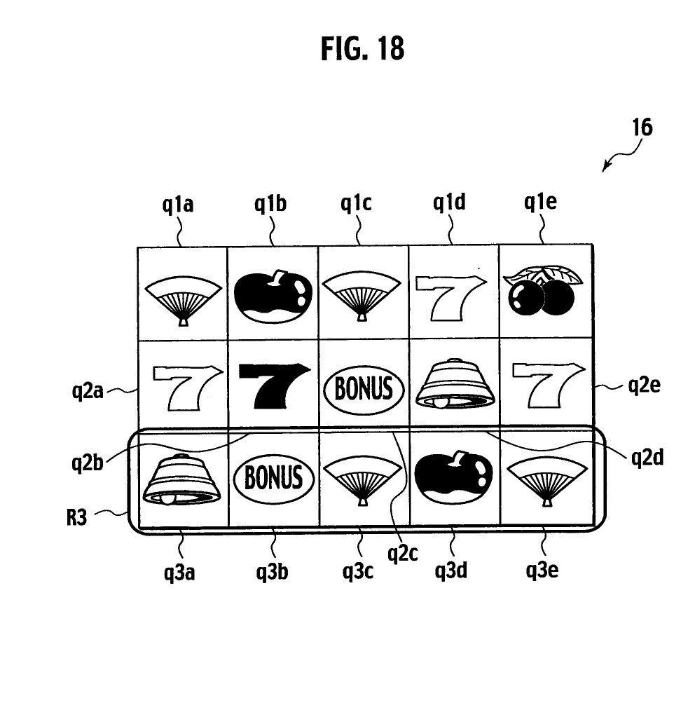

The controller 40 shown in FIG. 5 provides lighted display regions R1 to R3 around: the partitioned region in the first row (five display regions in the upper row); the partitioned region in the second row (five display regions in the middle row); and the partitioned region in the third row (five display regions in the lower row) among the total of fifteen display regions arranged in three rows and five columns on the display 16. Moreover, the controller 40 scrolls lighting of each of the lighted display regions R1 to R3 (Step S51). Specifically, the display regions are lighted sequentially in the order of: the lighted display region R1 including five display regions q1a, q1b, q1c, q1d and q1e shown in FIG. 16; the lighted display region R2 including five display regions q2a, q2b, q2c, q2d and q2e shown in FIG. 17; and the lighted display region R3 including five display regions q3a, q3b, q3c, q3d and q3e shown in FIG. 18. As a result, the lighted display regions R1 to R3 are lighted in the order of R1→R2→R3→R1→ . . . .

Next, the controller 40 receives an input from the stop operation switch 28 shown in FIG. 5 (Step S52).

The controller 40 determines whether or not the stop operation switch 28 is pressed (Step S53). When the stop operation switch 28 is pressed (YES in Step S53), the controller 40 stops scrolling of the lighted display regions R1 to R3 (Step S55). As a result, the display lightens one of the three lighted display regions R1 to R3.

Moreover, when the stop operation switch 28 is not pressed (NO in Step S53) and a predetermined time has passed (YES in Step S54), the controller 40 stops scrolling of the lighted display regions R1 to R3 (Step S55). Specifically, when the stop operation switch 28 is pressed or the predetermined time has passed after the start of scrolling of the lighted display regions R1 to R3, the scrolling of the lighted display regions R1 to R3 is stopped.

Thereafter, the controller 40 selects the five symbols displayed in the partitioned region that is the lighted display region lighted when the scrolling is stopped and transmits the selected symbols to the center controller 5 (Step S56). For example, when the scrolling is stopped in a state where the lighted display region R3 is lighted in the slot machine 10a as shown in FIG. 18, data on the symbols stopped in the partitioned region in the third (lower) row, in other words, five symbols “BELL”, “BONUS”, “FAN”, “BLUE APPLE” and “FAN” is transmitted to the center controller 5.

As a result, as shown in FIG. 1, the five symbols “BELL”, “BONUS”, “FAN”, “BLUE APPLE” and “FAN” described above are displayed in the display region in the third (lower) row on the common display 4. Similarly, when the symbols in the display region in the second (middle) row are selected in the slot machine 10b, the five symbols displayed in the second row in the slot machine 10b are displayed in the display region in the second (middle) row on the common display. Furthermore, when the symbols in the display region in the first (upper) row are selected in the slot machine 10c, the five symbols displayed in the first (upper) row in the slot machine 10c are displayed in the display region in the first (upper) row on the common display.

Next, with reference to FIG. 13, description will be given of the payout processing in Step S26 shown in FIG. 9.

The controller 40 shown in FIG. 5 determines whether or not any award (first award) is generated based on the symbols displayed on the display 16 (Step S71). In this step, generation of the award is determined based on the Step S28, shown in FIG. 9, whether or not the award is generated.

When it is determined that the award is generated (YES in Step S71), the controller 40 calculates a payout corresponding to the award (Step S72). In this step, a payout corresponding to the symbols displayed in the display regions on the display 16 is calculated by referring to the payout table shown in FIG. 7. For example, in the case where the symbols shown in FIG. 16 are displayed, since three “RED 7” symbols are displayed, a payout of 10 medals is provided with reference to FIG. 7.

Furthermore, the controller 40 determines whether or not the dividend command transmitted from the center controller 5 is received (Step S73). When the dividend command is received (YES in Step S73), in other words, when the dividend command is transmitted in Step S38 shown in FIG. 10 and this dividend command is received, the controller 40 calculates a payout based on the received dividend command (Step S74).

For example, when the symbol arrays including the fifteen symbols displayed in the display regions on the common display 4 include four “BONUS” symbols as shown in FIG. 1, a payout (a second award) for 60 medals is generated with reference to FIG. 7. Moreover, this payout for 60 medals is allocated to the three slot machines 10a to 10c as a dividend. Thus, a payout (a dividend) for 20 medals is generated for each of the slot machines 10a to 10c.

Thereafter, the controller 40 provides a payout that is a sum of the payout calculated in Step S72 and the payout calculated as the dividend in Step S74 (Step S75). Thus, in the case of the slot machine 10a, the payout of 40 medals is generated and provided in total.

As described above, in the gaming system 1 according to the first embodiment, when the common game execution determination is made in the CPU 71 for controlling the center controller in the center controller 5, the common game is executed by each of the slot machines 10a to 10c. Thereafter, when the symbol arrays displayed on the common display 4 by execution of the common game form a winning combination for generating an award, a payout is allocated as a dividend to each of the slot machines 10a to 10c. Therefore, it is possible to allow the player to have expectations for execution of the common game. Thus, entertainment properties can be improved.

Moreover, in the first embodiment described above, the description was given of the example where the slot machines 10a to 10c are provided adjacent to each other. However, each of the slot machines 10a to 10c can also be provided at remote locations. In this case, a common game is executed in the slot machines 10a to 10c provided at locations distant from each other.

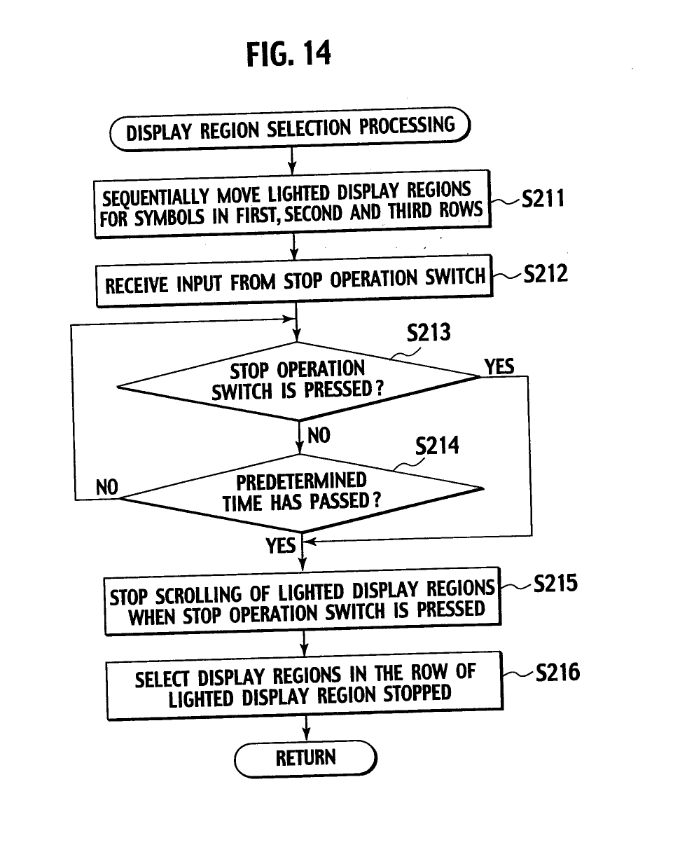

Next, description will be given of a first modified example of the first embodiment described above. In the first embodiment described above, as shown in FIG. 12, the input operation performed by use of the stop operation switch 28 is received and one of the lighted display regions R1 to R3 is selected. Meanwhile, a gaming system according to the first modified example is different from that of the first embodiment in a point that one of the lighted display regions R1 to R3 is selected at a timing of operating the stop operation switch 28 by the player. With reference to FIG. 14, description will be given below of display region selection processing (the processing in Step S24 shown in FIG. 9) according to the first modified example.

The controller 40 shown in FIG. 5 provides lighted display regions R1 to R3 around: the partitioned region in the first row (five display regions in the upper row); the partitioned region in the second row (five display regions in the middle row); and the partitioned region in the third row (five display regions in the lower row) among the total of fifteen display regions arranged in three rows and five columns on the display 16. Moreover, the controller 40 sequentially moves lighting of each of the lighted display regions R1 to R3 (Step S211). Specifically, the display regions are lighted sequentially in the order of the lighted display region R1 including five display regions q1a, q1b, q1c, q1d and q1e shown in FIG. 16, the lighted display region R2 including five display regions q2a, q2b, q2c, q2d and q2e shown in FIG. 17, and the lighted display region R3 including five display regions q3a, q3b, q3c, q3d and q3e shown in FIG. 18. As a result, the lighted display regions R1 to R3 are sequentially lighted in the order of R1→R2→R3→R1→ . . . . Unlike the scrolling described above, this movement speed of the lighting is performed at a slow speed so that the player can visually recognize the movement.

Next, the controller 40 receives an input from the stop operation switch 28 shown in FIG. 5 (Step S212).

The controller 40 determines whether or not the stop operation switch 28 is pressed (Step S213). When the stop operation switch 28 is pressed (YES in Step S213), the controller 40 stops the movement among the lighted display regions R1 to R3 when the stop operation switch 28 is pressed (Step S215). As a result, the display lightens one of the three lighted display regions R1 to R3.

Moreover, when the stop operation switch 28 is not pressed (NO in Step S213) and a predetermined time has passed (YES in Step S214), the controller 40 stops the movement among the lighted display regions R1 to R3 (Step S215). Specifically, when the stop operation switch 28 is pressed or the predetermined time has passed after the start of movement among the lighted display regions R1 to R3, the movement among the lighted display regions R1 to R3 is stopped when the stop operation switch 28 is pressed or the predetermined time has passed. In other words, the player can select an arbitrary partitioned region by operating the stop operation switch 28.

Thereafter, the controller 40 selects the five symbols displayed in the partitioned region that is the lighted display region lighted when the movement is stopped and transmits the selected symbols to the center controller 5 (Step S216).

As described above, in the first modified example of the first embodiment, the movement among the lighted display regions R1 to R3 is stopped when the stop operation switch 28 is operated. Thus, an arbitrary partitioned region can be selected by a stop operation performed by the player.

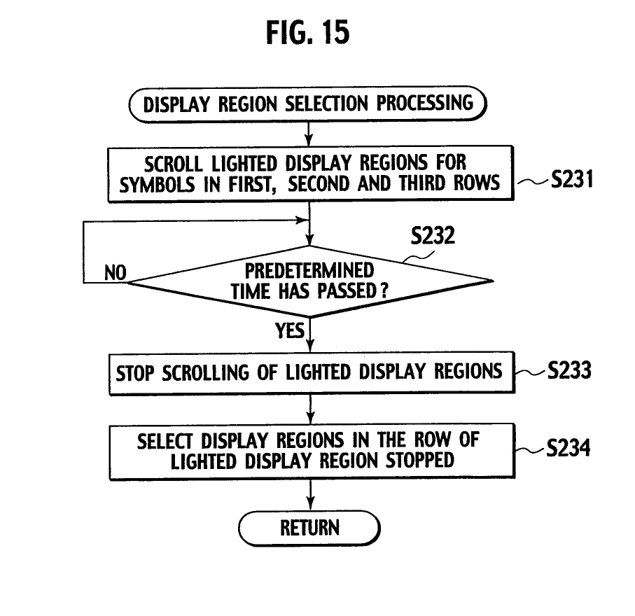

Next, description will be given of a second modified example of the first embodiment described above. A gaming system according to the second modified example is different from that of the first embodiment described above in a point that a partitioned region to be selected is automatically determined by a controller 40. With reference to FIG. 15, description will be given below of display region selection processing (the processing in Step S24 shown in FIG. 9) according to the second modified example.

The controller 40 shown in FIG. 5 provides lighted display regions R1 to R3 around: the partitioned region in the first row (five display regions in the upper row); the partitioned region in the second row (five display regions in the middle row); and the partitioned region in the third row (five display regions in the lower row) among the total of fifteen display regions arranged in three rows and five columns on the display 16. Moreover, the controller 40 scrolls lighting of each of the lighted display regions R1 to R3 (Step S231). Specifically, the display regions are lighted sequentially in the order of: the lighted display region R1 including five display regions q1a, q1b, q1c, q1d and q1e shown in FIG. 16, the lighted display region R2 including five display regions q2a, q2b, q2c, q2d and q2e shown in FIG. 17, and the lighted display region R3 including five display regions q3a, q3b, q3c, q3d and q3e shown in FIG. 18. As a result, the lighted display regions R1 to R3 are lighted in the order of R1→R2→R3→R1→ . . . .

Thereafter, the controller 40 determines whether or not a predetermined time has passed since start of scrolling (Step S232).

When the predetermined time has passed (YES in Step S232), the controller 40 stops scrolling of the lighted display regions R1 to R3 (Step S233). Thereafter, the controller 40 selects the five symbols displayed in the partitioned region that is the lighted display region lighted when the scrolling is stopped and transmits the selected symbols to the center controller 5 (Step S234).

As described above, in the second modified example of the first embodiment, a partitioned region to be selected is determined by automatically stopping the scrolling of the lighted display regions R1 to R3.

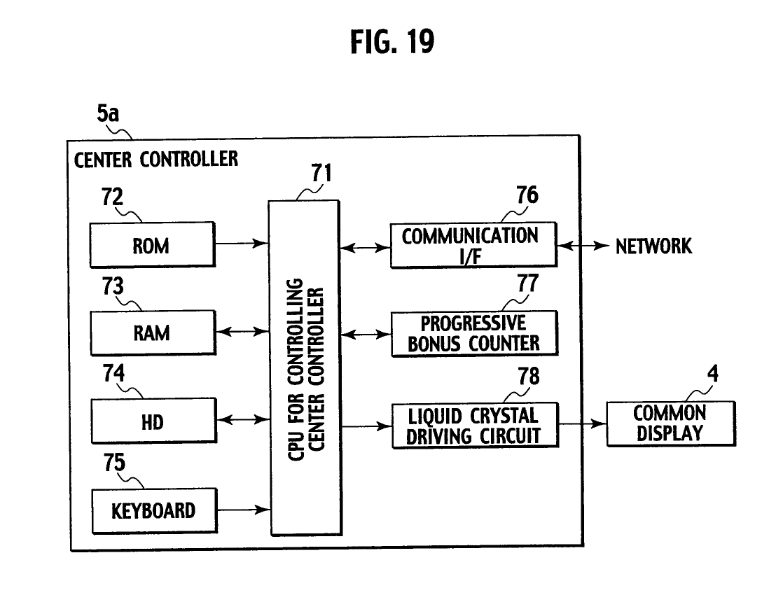

Next, a gaming system according to a second embodiment of the present invention will be described. The second embodiment is different from the first embodiment described above in a point that a center controller 5a includes a progressive bonus counter 77. FIG. 19 is a block diagram showing an electrical configuration of the center controller 5a used in the gaming system according to the second embodiment.

As shown in FIG. 19, the center controller 5a includes: a CPU 71 for controlling the center controller, which performs overall control of a slot game; a ROM 72; a RAM 73; a hard disk 74 storing programs and various data such as image data to be displayed on the common display 4; a keyboard 75 which receives an operation input by the manager; a communication I/F 76 which communicates with each of the slot machines 10a to 10c via the network; a liquid crystal driving circuit 78 which performs display control of the common display 4; and the progressive bonus counter 77 which cumulatively counts progressive bonus count values.

The CPU 71 for controlling the center controller determines whether or not to execute a common game. When it is determined that the common game is to be executed (when predetermined conditions are met), the CPU 71 for controlling the center controller executes the common game. Specifically, in the common game, some of the symbols displayed on the display 16 in each of the slot machines 10a to 10c are displayed on the common display 4 to form a symbol array. Thereafter, it is determined whether or not an award is generated based on the symbol array. A common game execution determination is made, for example, after a predetermined time passes or at a random timing.

The progressive bonus counter 77 cumulatively counts progressive bonus count values generated in the respective slot machines 10a to 10c.

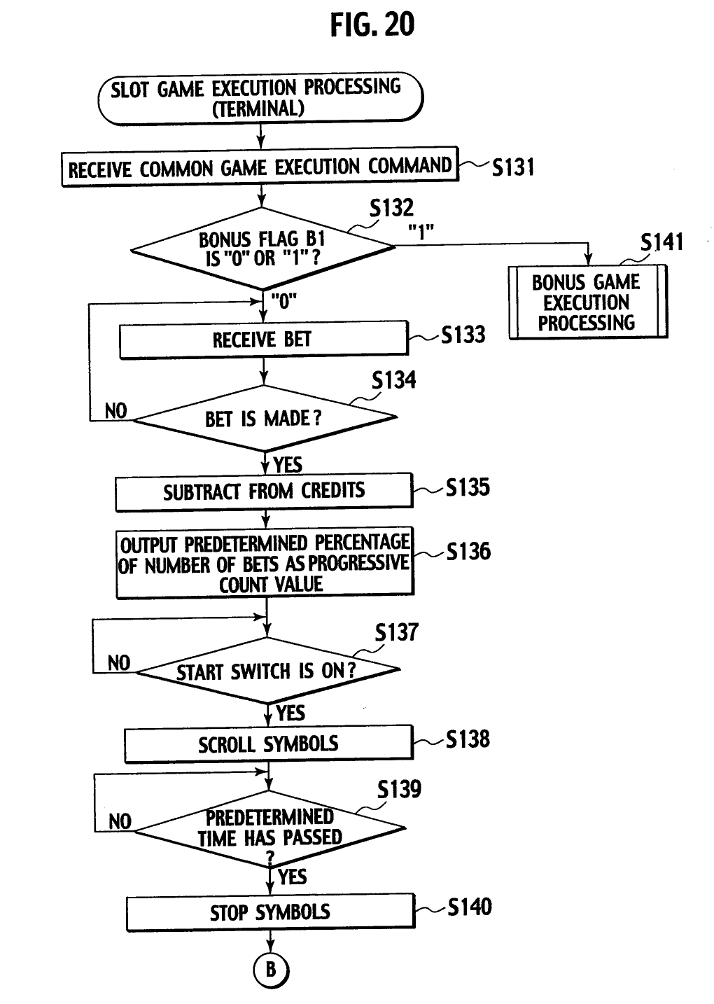

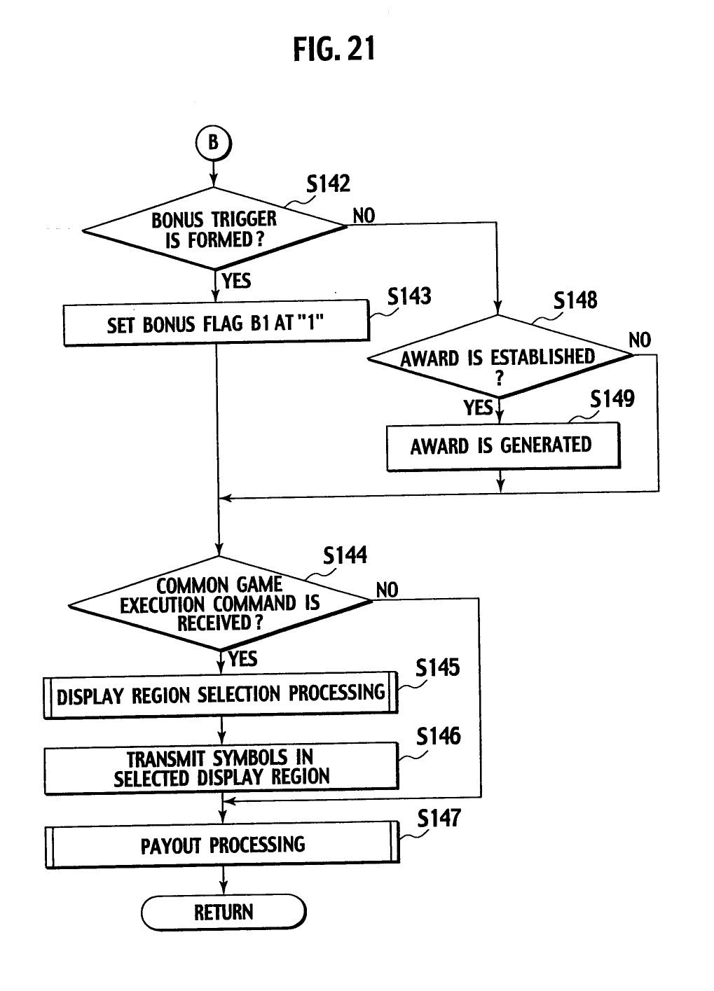

Next, with reference to flowcharts shown in FIGS. 20 and 21, description will be given of slot game execution processing performed by each of the slot machines 10a to 10c in the gaming system 1 according to the second embodiment of the present invention. Since the slot machines 10a to 10c perform the same slot game execution processing, description will be given of the slot game execution processing performed by the slot machine 10a only.

The controller 40 shown in FIG. 5 receives a common game execution command (Step S131). In this step, the controller 40 receives a common game execution command transmitted by the center controller 5 when the common game execution determination is made in the center controller 5 to execute a common game, which is common to the slot machines 10a to 10c.

Next, the controller 40 determines whether a bonus flag B1 is “0” or “1” (Step S132). The bonus flag B1 is a flag which is set to “1” when a bonus trigger to be described later is formed and is set to “0” when a bonus game is finished. The bonus flag B1 is stored in the RAM 110 shown in FIG. 5. Note that the bonus flag B1 is initially set to “0”.

When the bonus flag B1 is “1”, the controller 40 moves to bonus game execution processing (Step S141). Details of the bonus game execution processing are the same as those of the processing shown in FIG. 11 described above.

When the bonus flag B1 is “0”, the controller 40 receives a bet operation performed by the player (Step S133). Specifically, the controller 40 receives a bet operation performed when medals are inserted into the medal insertion slot 21 or when any of the MAX bet switch 24, the bet switch 25 and the spin repeat bet switch 26 are pressed.

When a bet is made (YES in Step S134), the controller 40 performs credit subtraction processing. Specifically, the controller 40 performs processing of subtracting the number of credits bet from the current number of credits (Step S135).

Thereafter, the controller 40 transmits, to the center controller 5, a predetermined percentage (for example, 5%) of the number of bets as a progressive bonus count value (Step S136). In the center controller 5, the progressive bonus count values thus transmitted are accumulated in the progressive bonus counter 77. Here, the percentage of the bet credits taken as the progressive bonus count value can be changed accordingly by an operation of the manager.

Subsequently, the controller 40 determines whether or not the start switch 27 is turned on (Step S137). When the start switch 27 is turned on (YES in Step S137), fifteen symbols displayed on the display 16 start being scrolled (Step S138).

Thereafter, the controller 40 determines whether or not a predetermined time (for example, 5 seconds) has passed since start of symbol being scrolled (Step S139). When the predetermined time has passed (YES in Step S139), the symbols stop being scrolled (Step S140).

Subsequently, the controller 40 determines whether or not a bonus trigger is formed in the fifteen symbols stopped (Step S142). To be more specific, the controller 40 determines whether or not five “BONUS” symbols appear as shown in FIG. 7. When five “BONUS” symbols appear (YES in Step S142), the controller 40 sets the bonus flag B1 to “1” (Step S143).

On the other hand, when no bonus trigger is formed, in other words, five “BONUS” symbols do not appear (NO in Step S142), the controller 40 determines whether or not an award (a first award) is established based on the fifteen symbols stopped. Specifically, the controller 40 determines whether or not any one of awards listed in the payout table shown in FIG. 7 is established (Step S148). When the award is established (YES in Step S148), the controller 40 generates the award (the first award) corresponding to the symbol combination (Step S149).

Thereafter, the controller 40 determines whether or not the common game execution command transmitted by the center controller 5 is received (Step S144). Specifically, the controller 40 determines whether or not the common game execution command has been received in Step S131 shown in FIG. 20.

When the common game execution command is received (YES in Step S144), the controller 40 executes display region selection processing (Step S145). In the display region selection processing, any one of partitioned regions (R1 to R3 shown in FIGS. 16 to 18), which are set in a total of fifteen display regions arranged in three rows and five columns, is selected. Detailed procedures of the display region selection processing are the same as those of the processing shown in FIGS. 12, 14 and 15 described above.

The controller 40 transmits data on the symbols displayed in the partitioned region selected by the display region selection processing in Step S145 to the center controller 5 (Step S146). In response, the center controller 5 forms symbol arrays based on the symbol data transmitted from each of the slot machines 10a to 10c and displays the symbol arrays on the common display 4.

The controller 40 executes payout processing on the award (the first award) generated in Step S149 and a dividend (for the second award) based on a dividend command transmitted from the center controller 5 (Step S147). Details of the payout processing are the same as those of the processing shown in FIG. 13 described above. Thus, the slot game execution processing according to the second embodiment is completed.

Moreover, the common game execution processing performed by the center controller 5 in the second embodiment is the same as the processing shown in FIG. 10 described above. However, in the second embodiment, a dividend indicated by the dividend command transmitted in Step S38 shown in FIG. 10 is based on a cumulative count number in the progressive bonus counter 77. For example, when a cumulative count value in the progressive bonus counter 77 is “$1,058,214”, a dividend corresponding to a part of or all of this count value is generated.

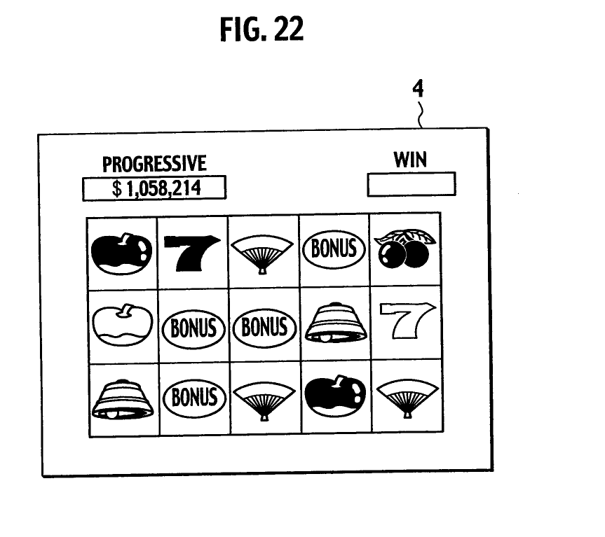

FIG. 22 shows a display example of the common display 4 in the gaming system 1 according to the second embodiment. In an upper left area of the common display 4, a progressive bonus count value currently accumulated in the progressive bonus counter 77 is displayed. Thus, the player can recognize the current progressive bonus count value with a glance at the common display 4.

As described above, in the gaming system 1 according to the second embodiment, some of the bets made when the slot game is executed in each of the slot machines 10a to 10c are accumulated, as the progressive bonus count value, in the progressive bonus counter 77 included in the center controller 5. Moreover, when a common game is executed and an award (a second award) is generated as an outcome of the common game, all of or a part of the progressive bonus count value accumulated in the progressive bonus counter 77 is provided as a dividend to each of the slot machines 10a to 10c. Thus, the player can get many payouts.

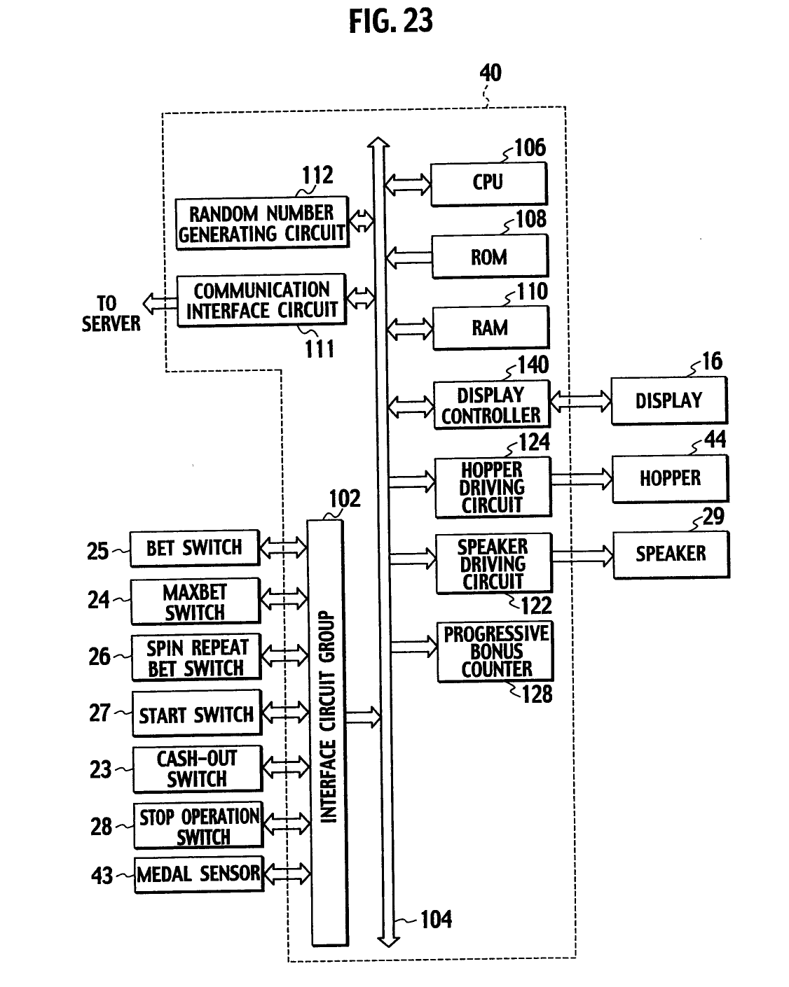

Next, a gaming system according to a third embodiment of the present invention will be described. FIG. 23 is a block diagram showing an electrical configuration of each of slot machines 10a to 10c according to the third embodiment.

As shown in FIG. 23, each of the slot machines 10a to 10c according to the third embodiment is different from that of the first embodiment in a point that a controller 40 includes a progressive bonus counter 128 in addition to the configuration shown in FIG. 5.

The progressive bonus counter 128 cumulatively counts a predetermined percentage of bets made when a slot game is executed in each of the slot machines 10a to 10c. For example, when 20 medals or 20 credits are bet, a bet, corresponding to 1 medal that is 5% of 20 medals, is accumulated in the progressive bonus counter 128. Since the other configuration of the controller 40 is the same as that shown in FIG. 5, detailed description thereof will be omitted.

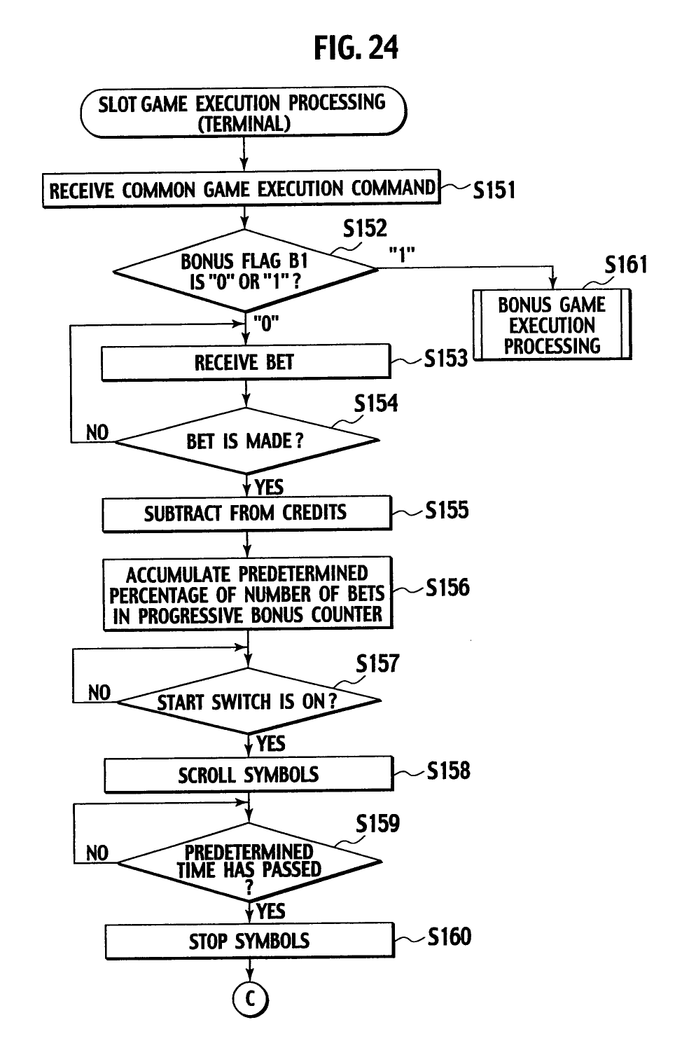

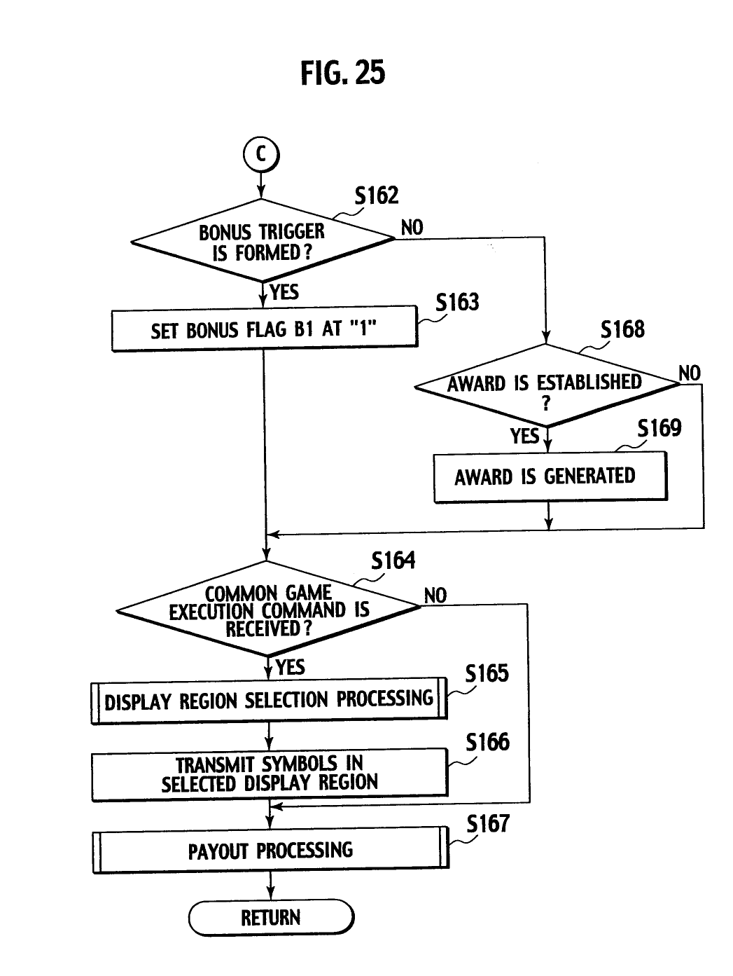

Next, with reference to flowcharts shown in FIGS. 24 and 25, description will be given of slot game execution processing performed by each of the slot machines 10a to 10c in the gaming system 1 according to the third embodiment of the present invention. Since the slot machines 10a to 10c perform the same slot game execution processing, description will be given of the slot game execution processing performed by the slot machine 10a only.

The controller 40 shown in FIG. 5 receives a common game execution command (Step S151). In this step, the controller 40 receives a common game execution command transmitted by the center controller 5 when the common game execution determination is made in the center controller 5 to execute a common game, which is common to the slot machines 10a to 10c.

Next, the controller 40 determines whether a bonus flag B1 is “0” or “1” (Step S152). The bonus flag B1 is a flag which is set to “1” when a bonus trigger to be described later is formed and is set to “0” when a bonus game is finished. The bonus flag B1 is stored in the RAM 110 shown in FIG. 5. Note that the bonus flag B1 is initially set to “0”.

When the bonus flag B1 is “1”, the controller 40 moves to bonus game execution processing (Step S161). Details of the bonus game execution processing are the same as those of the processing shown in FIG. 11 described above.

When the bonus flag B1 is “0”, the controller 40 receives a bet operation performed by the player (Step S153). Specifically, the controller 40 receives a bet operation performed when medals are inserted into the medal insertion slot 21 or when any of the MAX bet switch 24, the bet switch 25 and the spin repeat bet switch 26 are pressed.

When a bet is made (YES in Step S154), the controller 40 performs credit subtraction processing. Specifically, the controller 40 performs processing of subtracting the number of credits bet from the current number of credits (Step S155).

Thereafter, the controller 40 accumulates a predetermined percentage (for example, 5%) of the number of bets in the progressive bonus counter 128 (see FIG. 23) (Step S156). Here, the percentage of the bet credits taken as a progressive bonus count value is changeable accordingly by an operation of the manager.

Subsequently, the controller 40 determines whether or not the start switch 27 is turned on (Step S157). When the start switch 27 is turned on (YES in Step S157), fifteen symbols displayed on the display 16 start being scrolled (Step S158).

Thereafter, the controller 40 determines whether or not a predetermined time (for example, 5 seconds) has passed since start of symbol being scrolled (Step S159). When the predetermined time has passed (YES in Step S159), the symbols stop being scrolled (Step S160).

Subsequently, the controller 40 determines whether or not a bonus trigger is formed in the fifteen symbols stopped (Step S162 in FIG. 25). To be more specific, the controller 40 determines whether or not five “BONUS” symbols appear as shown in FIG. 7. When five “BONUS” symbols appear (YES in Step S162), the controller 40 sets the bonus flag B1 to “1” (Step S163).

On the other hand, when no bonus trigger is formed, in other words, five “BONUS” symbols do not appear (NO in Step S162), the controller. 40 determines whether or not an award (a first award) is established based on the fifteen symbols stopped. Specifically, the controller 40 determines whether or not any one of awards listed in the payout table shown in FIG. 7 is established (Step S168). When awardt is established (YES in Step S168), the controller 40 generates the award (the first award) corresponding to the symbol combination (Step S169).

Thereafter, the controller 40 determines whether or not the common game execution command transmitted by the center controller 5 is received (Step S164). Specifically, the controller 40 determines whether or not the common game execution command has been received in Step S151 shown in FIG. 24.

When the common game execution command is received (YES in Step S164), the controller 40 executes display region selection processing (Step S165). In the display region selection processing, any one of partitioned regions (R1 to R3 shown in FIGS. 16 to 18), which are set in a total of fifteen display regions arranged in three rows and five columns, is selected. Detailed procedures of the display region selection processing are the same as those of the processing shown in FIGS. 12, 14 and 15 described above.

The controller 40 transmits data on the symbols displayed in the partitioned region selected by the display region selection processing in Step S165 to the center controller 5 (Step S166). In response, the center controller 5 forms symbol arrays based on the symbol data transmitted from each of the slot machines 10a to 10c and displays the symbol arrays on the common display 4.

The controller 40 executes payout processing on the award (the first award) generated in Step S169 and a dividend (for the second award) based on a dividend command transmitted from the center controller 5 (Step S167). The payout processing will be described in detail later.

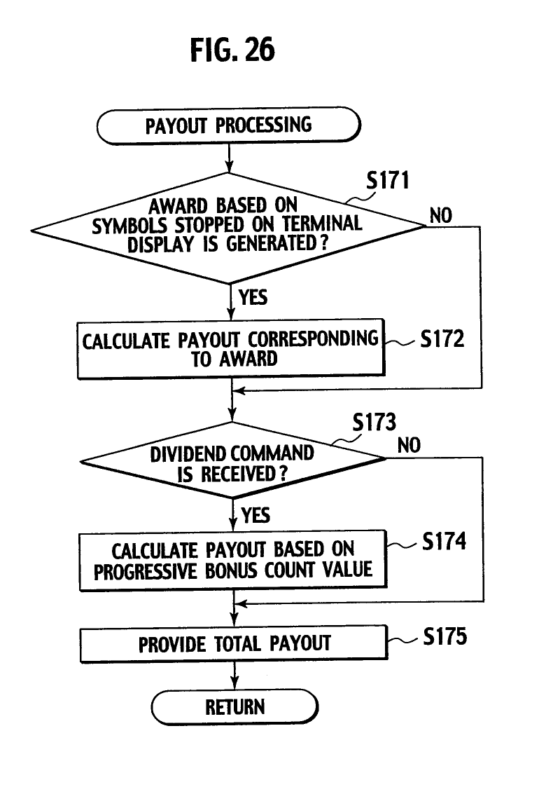

Next, with reference to FIG. 26, description will be given of the payout processing in Step S167 shown in FIG. 25.

The controller 40 shown in FIG. 23 determines whether or not any award (first award) is generated based on the symbols displayed on the display 16 (Step S171). In this step, generation of the award is determined based on whether or not the award is generated in Step S168 shown in FIG. 25.

When it is determined that the award is generated (YES in Step S171), the controller 40 calculates a payout corresponding to the award (Step S172). In this step, a payout corresponding to the symbols displayed in the display regions on the display 16 is calculated by referring to the payout table shown in FIG. 7. For example, in the case where the symbols shown in FIG. 16 are displayed in the fifteen display regions, since three “RED 7” symbols are displayed, a payout of 10 medals is provided with reference to FIG. 7.

Furthermore, the controller 40 determines whether or not the dividend command transmitted from the center controller 5 is received (Step S173). When the dividend command is received (YES in Step S173), in other words, when the dividend command is transmitted in Step S38 shown in FIG. 10 and this dividend command thus transmitted is received, the controller 40 calculates a payout as a dividend based on the progressive bonus count value accumulated in the progressive bonus counter 128 (Step S174). For example, when the progressive bonus count value is “$2,401,332”, a payout (a dividend) corresponding to a part of or all of this count value is generated. Here, the count values in the respective progressive bonus counters 128 among each of the slot machines 10a to 10c are different. Thus, payouts (dividends) generated in the respective slot machines 10a to 10c are not the same. Specifically, in the slot machine in which more wagers are placed, the count value in the progressive bonus counter 128 is increased. Thus, more payouts (dividends) are to be generated.

Thereafter, the controller 40 provides a payout that is a sum of the payout calculated in Step S172 and the payout calculated as the dividend in Step S174 (Step S175). Thus, the slot game execution processing according to the third embodiment is completed.

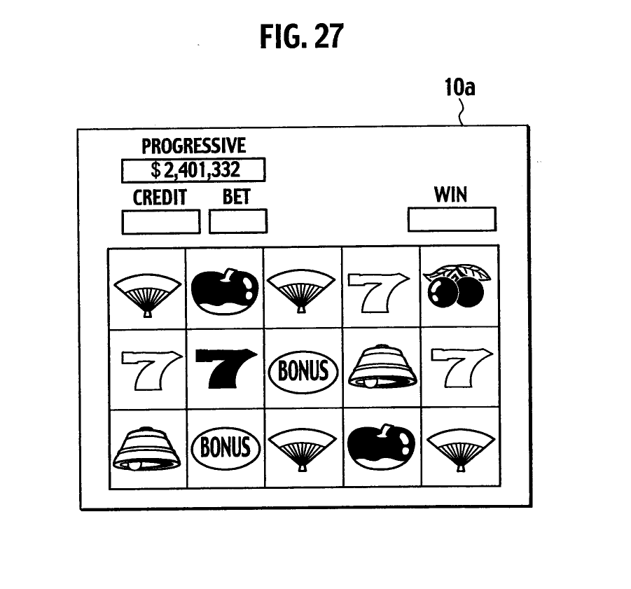

FIG. 27 shows a display example of the display 16 in the slot machine 10a in the gaming system 1 according to the third embodiment. In an upper left area of the display 16, a progressive bonus count value currently accumulated in the progressive bonus counter 128 is displayed. Thus, the player can recognize the current progressive bonus count value with a glance at the display 16.

As described above, in the gaming system 1 according to the third embodiment, some of the bets made when the slot game is executed in each of the slot machines 10a to 10c are accumulated, as the progressive bonus count value, in the progressive bonus counter 128. Moreover, when a common game is executed and an award (a second award) is generated as an outcome of the common game, all of or a part of the progressive bonus count value accumulated in the progressive bonus counter 128 per each of the slot machines 10a to 10c is provided as a dividend to each of the slot machines 10a to 10c. Thus, the player can get more payouts.

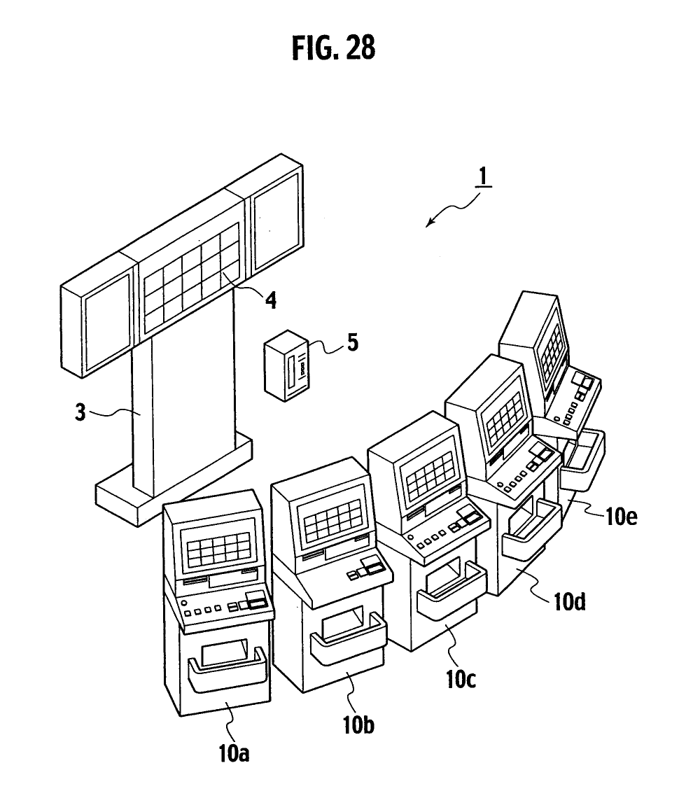

Next, a gaming system according to a fourth embodiment of the present invention will be described. FIG. 28 is a configuration diagram showing an entire gaming system 1a according to the fourth embodiment. The fourth embodiment is different from the first to third embodiments described above in a point that the gaming system 1a includes five slot machines 10a to 10e.

As shown in FIG. 28, the gaming system 1a according to the fourth embodiment includes: a common display 4 provided on a supporting member 3; the five slot machines 10a to 10e disposed in front of the common display 4; and a center controller 5 configured to perform overall control of the slot machines 10a to 10e and to perform display control of the common display 4.

Each of the slot machines 10a to 10e is configured to allow the player to execute a slot game. As described later, when common game execution determination is made (predetermined conditions are met) in the center controller 5, a common game is executed.

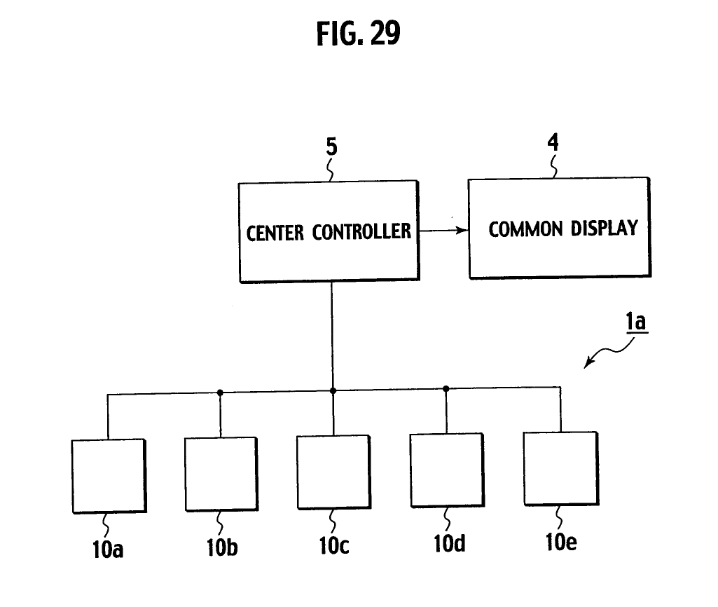

FIG. 29 is a network connection diagram of the gaming system 1a according to the fourth embodiment. As shown in FIG. 29, the five slot machines 10a to 10e are connected to the center controller 5 via a network. Furthermore, the center controller 5 is connected to the common display 4. Each of the slot machines 10a to 10e has the same electrical configuration as that shown in FIG. 5.

In the fourth embodiment, winning combinations of symbols in the slot game to be executed in each of the slot machines 10a to 10e are different from those described above. In the first to third embodiments described above, an award is generated when a predetermined number of the same scatter symbols are stopped in the display regions arranged in three rows and five columns, which are provided on the display 16. Specifically, as shown in the payout table of FIG. 7, for example, when three “BLUE 7” symbols are stopped, a payout of 20 medals is provided.

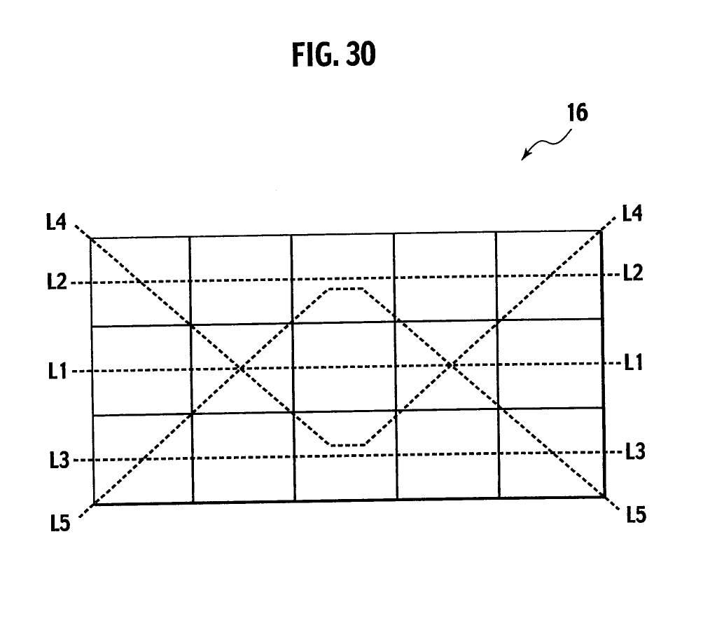

Meanwhile, in the fourth embodiment, as shown in FIG. 30, five paylines L1 to L5 are set and an award (a second award) is generated when predetermined symbols are stopped on those paylines L1 to L5. As shown in FIG. 30, the payline L1 is a line in the second (middle) row, the payline L2 is a line in the first (upper) row, the payline L3 is a line in the third (lower) row, the payline L4 is a line that forms a “V” shape starting from the upper row, and the payline L5 is a line that forms an “inverted V” shape starting from the lower row.

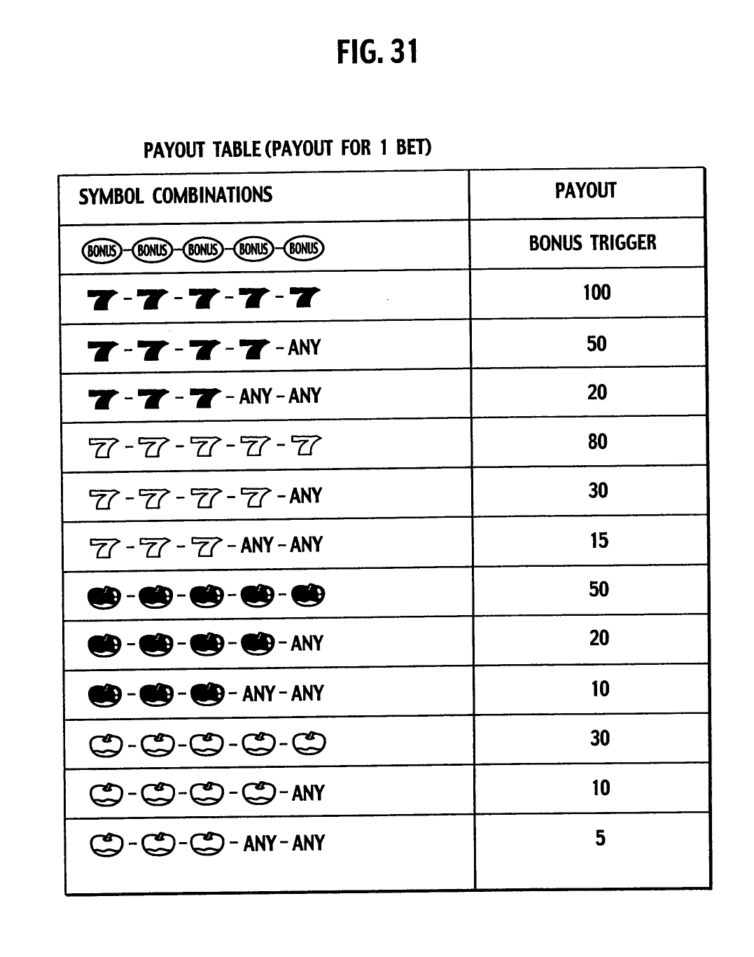

FIG. 31 shows a payout table showing a relationship between symbols stopped on each of the paylines L1 to L5 and payouts. In this payout table, for example, when five “BONUS” symbols are stopped on any one of the paylines, a bonus trigger is formed to make a shift to a bonus game. Moreover, when five “BLUE 7” symbols are stopped on any one of the paylines, an award of 100 medals is generated.

Next, description will be given of slot game execution processing performed by each of the slot machines 10a to 10e in the gaming system la according to the fourth embodiment. The slot game execution processing is basically the same as the processing shown in FIGS. 8 and 9 described above. The fourth embodiment is different from the embodiments described above only in the display region selection processing in Step S24 shown in FIG. 9.

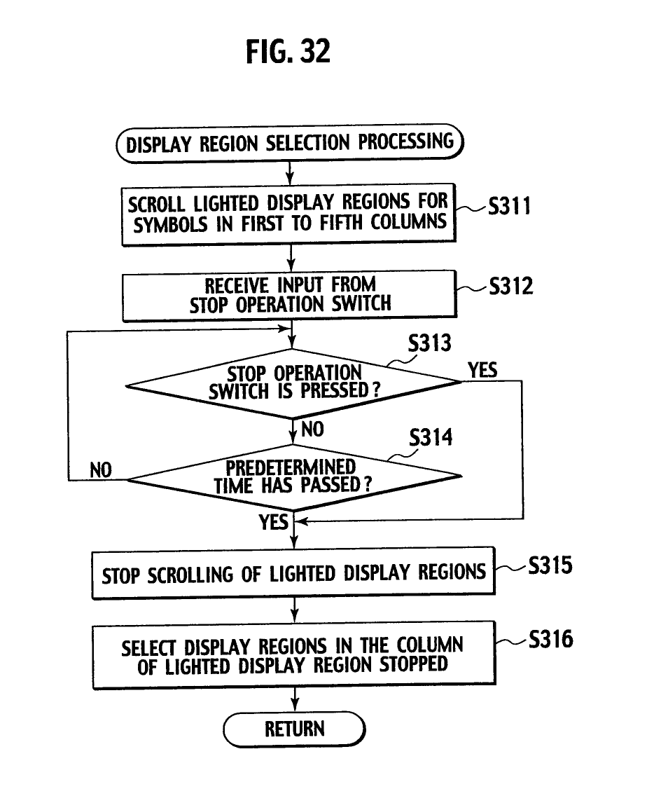

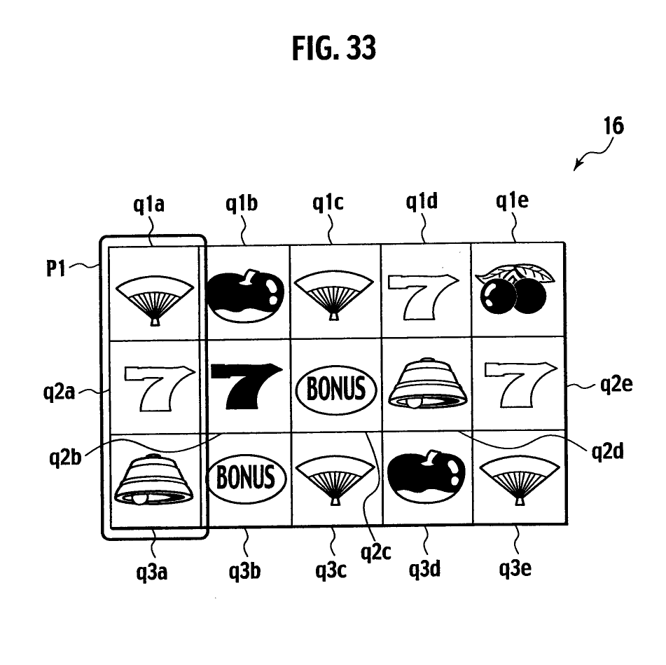

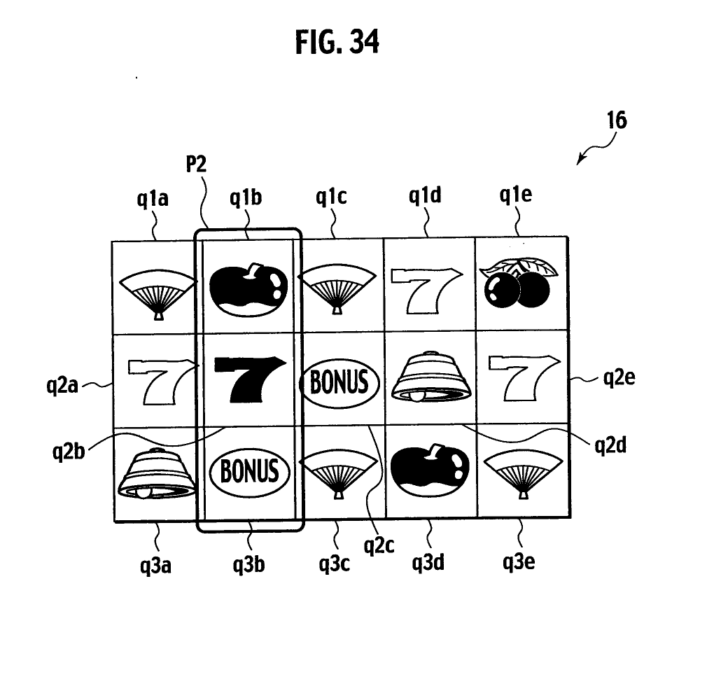

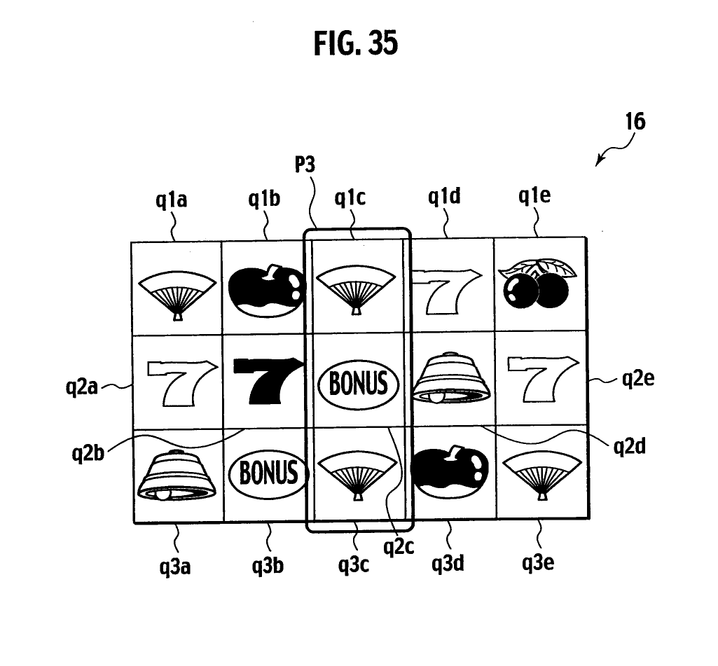

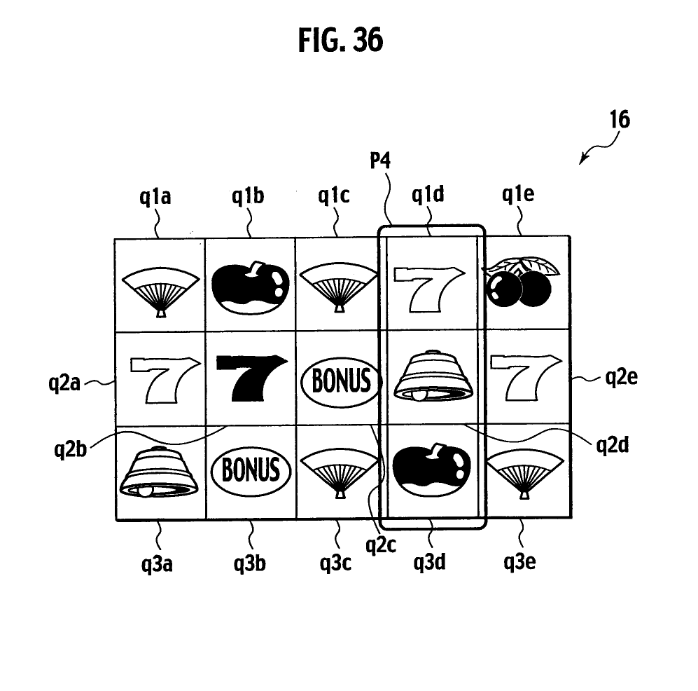

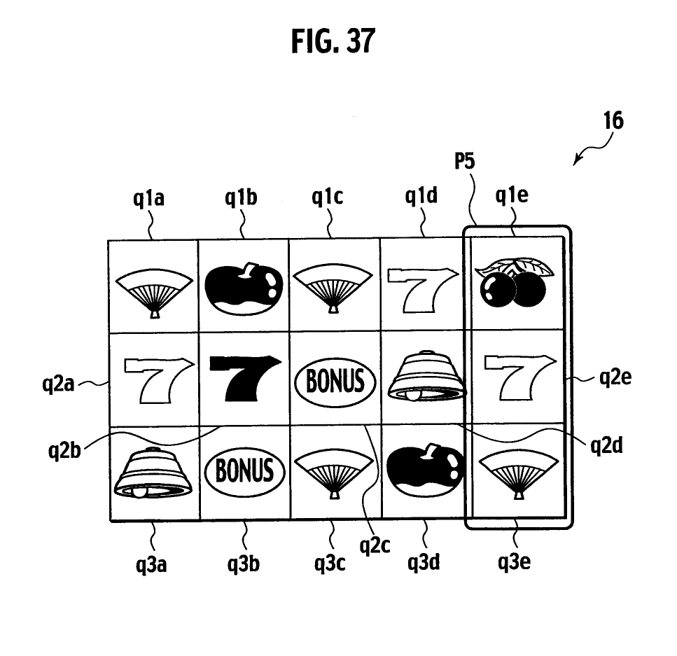

With reference to a flowchart shown in FIG. 32, description will be given below of the display region selection processing according to the fourth embodiment. The controller 40 shown in FIG. 5 sets lighted display regions P1 to P5 (see FIGS. 33 to 37) around: the partitioned region in the first column (three display regions q1a, q2a and q3a); the partitioned region in the second column (three display regions q1b, q2b and q3b); the partitioned region in the third column (three display regions q1c, q2c and q3c); the partitioned region in the fourth column (three display regions q1d, q2d and q3d); and the partitioned region in the fifth column (three display regions q1e, q2e and q3e) among a total of fifteen display regions arranged in three rows and five columns on the display 16. Moreover, the controller 40 scrolls lighting of each of the lighted display regions P1 to P5 (Step S311). Specifically, the lighted display region P1 shown in FIG. 33, the lighted display region P2 shown in FIG. 34, the lighted display region P3 shown in FIG. 35, the lighted display region P4 shown in FIG. 36 and the lighted display region P5 shown in FIG. 37 are sequentially lighted. As a result, the lighted display regions P1 to P5 are lighted in the order of P1→P2→P3→P4→P5→P1→ . . . .

Next, the controller 40 receives an input from the stop operation switch 28 shown in FIG. 5 (Step S312).

The controller 40 determines whether or not the stop operation switch 28 is pressed (Step S313). When the stop operation switch 28 is pressed (YES in Step S313), the controller 40 stops scrolling of the lighted display regions P1 to P5 (Step S315). As a result, the display lightens one of the five lighted display regions P1 to P5.

Moreover, when the stop operation switch 28 is not pressed (NO in Step S313) and a predetermined time has passed (YES in Step S314), the controller 40 stops scrolling of the lighted display regions P1 to P5 (Step S315). Specifically, when the stop operation switch 28 is pressed or the predetermined time has passed after the start of scrolling of the lighted display regions P1 to P5, the scrolling of the lighted display regions P1 to P5 is stopped.

Thereafter, the controller 40 selects the three symbols displayed in the partitioned region that is the lighted display region lighted when the scrolling is stopped and transmits the selected symbols to the center controller 5 (Step S316). For example, when the scrolling is stopped in a state where the lighted display region P1 is lighted in the slot machine 10a as shown in FIG. 33, data on the symbols stopped in the partitioned region (q1a, q2a and q3a) in the left column, in other words, three symbols “FAN”, “RED 7” and “BELL” are transmitted to the center controller 5.

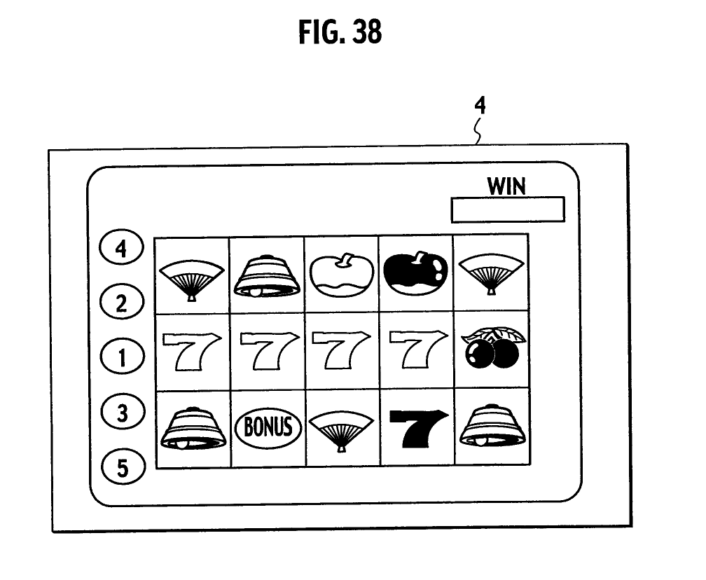

As a result, as shown in FIG. 38, the three symbols “FAN”, “RED 7” and “BELL” described above are displayed in the display region in the left column (first column) on the common display 4. Similarly, when the symbols in the display region in the second column are selected in the slot machine 10b, those symbols are displayed in the display region in the second column on the common display 4. When the symbols in the display region in the third column are selected in the slot machine 10c, those symbols are displayed in the display region in the third column on the common display 4. Moreover, when the symbols in the display region in the fourth column are selected in the slot machine 10d, those symbols are displayed in the display region in the fourth column on the common display 4. Furthermore, when the symbols in the display region in the fifth column are selected in the slot machine 10e, those symbols are displayed in the display region in the fifth column on the common display 4.

In the case where the symbols shown in FIG. 38 are stopped in the display regions on the common display 4, four “RED 7” symbols appear on the payline L1 set on the common display 4. Thus, with reference to the payout table shown in FIG. 31, an award (a second award) of 30 medals is generated. As a result, 30 medals are divided into five equal parts, and then allocated and distributed to the five slot machines 10a to 10e. Specifically, each of the slot machines 10a to 10e can get 6 medals as a dividend.

Thus, as in the case of the first embodiment described above, the gaming system 1a according to the fourth embodiment can also allow the player to have expectations for execution of the common game. Consequently, entertainment properties can be improved.

Although the embodiments of the present invention have been described above, the concrete examples described are only for illustrative purposes and the present invention is not limited thereto. Moreover, the specific configurations of the respective means and the like can be appropriately changed in design. Furthermore, the effects described in the embodiments of the present invention are merely listed as preferred effects achieved by the present invention. The effects of the present invention are not limited to those described in the embodiments of the present invention.

In addition, in the detailed description above, the characteristic portions are mainly described in order to make the present invention easily understandable. The present invention is not limited to the embodiments described in the detailed description above, and can be applied to the other embodiments, and its range of application is wide. Also, the terms and the terminology used in the present specification are used only for the purpose of explaining the present invention precisely, and not used for the purpose of limiting the interpretation of the present invention. Also, for those skilled in the art, it should be easy to contemplate other configurations, systems, methods, etc., that are contained in the concept of the present invention, from the content of the invention described in the present specification. Consequently, the description of the scope of claims should be construed as containing equivalent configurations within a range of not deviating from a range of the technical ideas of the present invention. Also, the purpose of the abstract is to make it possible for the patent office, the general public organizations, and technicians and the like who belong to the present technical field and who are not thoroughly familiar with patent and law terms or specialized terms, to quickly judge the technical content and its essence of the present application by a simple search. Consequently, the abstract is not intended to limit the scope of the invention which should be evaluated by the description of the scope of claims. Also, in order to sufficiently understand the purpose of the present invention and the effects specific to the present invention, they should preferably be interpreted by sufficiently referring to the documents and the like that are already disclosed in public.

Also, the detailed description above contains the processing to be executed by a computer. The explanations and expressions in the above are described for the purpose of facilitating the most efficient understanding by those skilled in the art. In the present specification, each step used in deriving one result should be understood as a processing without a self-contradiction. Also, at each step, transmission and reception, recording, etc., of electric or magnetic signals will be carried out. In the processing at each step, such signals are expressed by bits, values, symbols, letters, terms, numbers, etc., but it should be noted that they are used simply because they are convenient for the purpose of explanation. Also, there are cases where the processing at each step is described by an expression common to the human behavior, but the processing described in the present specification is to be executed by various devices in principle. Also, the other configuration required in carrying out each step will be obvious from the above description.

What is claimed is:

1. A gaming system comprising:
a plurality of gaming terminals;
a center controller connected to each of the gaming terminals; and
a common display connected to the center controller,
wherein each of the gaming terminals includes
a terminal display having a plurality of display regions with symbols being arranged in the display regions, the display regions being divided into a plurality of partitioned regions, and
a terminal controller configured to
(a) execute a slot game to rearrange the symbols in the display regions upon receipt of a bet,
(b) generate a first award corresponding to a combination of the rearranged symbols, and
(c) select one of the partitioned regions upon receipt of an external input, and
wherein the center controller is configured to
form a symbol array by displaying on the common display the symbols rearranged in the display regions included in the partitioned regions selected by the gaming terminals upon a predetermined condition, and
upon generation of a second award based on the symbol array, distribute a dividend for the second award to each of the gaming terminals.

2. The gaming system according to claim 1, wherein the terminal controller is configured to
scroll lighting of a display frame surrounding one of the respective partitioned regions through the respective partitioned regions upon the predetermined condition, and
set, as the selected partitioned region, the partitioned region surrounded by the lighting of the display frame being stopped.

3. The gaming system according to claim 1, wherein
the terminal controller is configured to set a part of the bet as a progressive bonus count value, and
the center controller further includes a progressive bonus counter configured to count the progressive bonus count value in each of the terminal controllers as a cumulative count value and is configured to distribute a part of or all of an amount corresponding to the cumulative count value in the progressive bonus counter to each of the gaming terminals as the dividend for the second award upon generation of the second award.

4. A gaming system comprising:
a plurality of gaming terminals;
a center controller connected to each of the gaming terminals; and
a common display connected to the center controller,
wherein each of the gaming terminals includes
an operation switch operable by a player,
a terminal display having a plurality of display regions with symbols being arranged in the display regions, the display regions being divided into a plurality of partitioned regions, and
a terminal controller configured to
(a) execute a slot game to rearrange the symbols in the display regions upon receipt of a bet,
(b) generate a first award corresponding to a combination of the rearranged symbols,
(c) upon a predetermined condition, receive an operation input from the operation switch and scroll lighting of a display frame surrounding one of the respective partitioned regions through the respective partitioned regions, and
(d) stop the scrolling of the lighting of the display frame when the operation switch is operated and select the partitioned region surrounded by the lighting of the display frame when the scrolling is stopped, and
wherein the center controller is configured to
form a symbol array by displaying on the common display the symbols rearranged in the display regions included in the partitioned regions selected by the gaming terminals upon the predetermined condition, and
upon generation of a second award based on the symbol array, distribute a dividend for the second award to each of the gaming terminals.

5. The gaming system according to claim 4, wherein
the terminal controller is configured to set a part of the bet as a progressive bonus count value, and
the center controller further includes a progressive bonus counter configured to count the progressive bonus count value in each of the terminal controllers as a cumulative count value and is configured to distribute a part of or all of an amount corresponding to the cumulative count value in the progressive bonus counter to each of the gaming terminals as the dividend for the second award upon generation of the second award.

6. A gaming system comprising:
a plurality of gaming terminals;
a center controller connected to each of the gaming terminals; and
a common display connected to the center controller,
wherein each of the gaming terminals includes
a terminal display having a plurality of display regions with symbols being arranged in the display regions, the display regions being divided into a plurality of partitioned regions,
a progressive bonus counter configured to count a progressive bonus count value, and
a terminal controller configured to
(a) execute a slot game to rearrange the symbols in the display regions upon receipt of a bet,
(b) accumulate a part of the bet in the progressive bonus counter as a cumulative count value,
(c) generate a first award corresponding to a combination of the rearranged symbols, and
(d) select one of the partitioned regions upon receipt of an external input,
wherein the center controller is configured to, upon a predetermined condition, form a symbol array by displaying on the common display the symbols rearranged in the display regions included in the partitioned regions selected by the gaming terminals and determine whether or not a second award based on the symbol array is generated, and
wherein the gaming terminal is configured to generate a part of or all of an amount corresponding to the cumulative count value in the progressive bonus counter as a dividend for the second award upon generation of the second award.

7. The gaming system according to claim 6, wherein the terminal controller is configured to
scroll lighting of a display frame surrounding one of the respective partitioned regions through the respective partitioned regions upon the predetermined condition, and
set, as the selected partitioned region, the partitioned region surrounded by the lighting of the display frame being stopped.

8. A method for controlling a gaming system, the method comprising:
executing slot games in a plurality of gaming terminals;
upon a predetermined condition, forming a symbol array by displaying on a common display, among symbols displayed in display regions as outcomes of the slot games executed in the gaming terminals, the symbols in the display regions included in partitioned regions selected at the gaming terminals, one partitioned region being selected at each of the gaming terminals by an operation of an operation switch; and
upon generation of an award based on the symbol array, distributing a dividend for the award to each of the gaming terminals.

9. The method according to claim 8, further comprising: for each of the gaming terminals,
scrolling lighting of a display frame surrounding one of the respective partitioned regions through the respective partitioned regions upon the predetermined condition; and
setting, as the selected partitioned region, the partitioned region surrounded by the lighting of the display frame being stopped.

10. The method according to claim 8, further comprising: for each of the gaming terminals,
upon the predetermined condition, receiving an operation input from the operation switch and scrolling lighting of a display frames surrounding one of the respective partitioned regions through the respective partitioned regions;
stopping the scrolling of the lighting of the display frame when the operation switch is operated; and
setting, as the selected partitioned region, the partitioned region surrounded by the lighting of the display frame when the scrolling is stopped.
